(19) United States
(12) Patent Application Publication
(10) Pub. No.: US 2026/0308037 A1
(43) Pub. Date: Oct. 8, 2026

(54) Integrated Ocean Alkalinity Enhancement And Seawater Desalination

(71) Applicant: Ebb Carbon Inc., South San Francisco, CA (US)

(72) Inventors: Jeremy Loretz, San Mateo, CA (US); Todd Pelman, Moss Beach, CA (US); Aparna Garg, San Mateo, CA (US); Kealyn Thaut, San Francisco, CA (US)

(73) Assignee: Ebb Carbon, Inc., South San Francisco, CA (US)

(21) Appl. No.: 19/633,924

(22) Filed: Mar. 30, 2026

Related U.S. Application Data
(63) Continuation-in-part of application No. 19/092,576, filed on Mar. 27, 2025.
(60) Provisional application No. 63/641,910, filed on May 2, 2024.
(60) Provisional application No. 63/716,029, filed on Nov. 4, 2024.

(51) Int. Cl. C02F 9/00; C02F 1/44; C02F 1/46; C02F 103/08

(52) U.S. Cl. CPC C02F 9/00; C02F 1/441; C02F 1/4604; C02F 2103/08; C02F 2201/005; C02F 2209/001; C02F 2209/003; C02F 2209/06; C02F 2209/07; C02F 2301/08

(57) ABSTRACT

A reverse osmosis (RO) unit's operating efficiency is enhanced by a reduced-salt stream and acid/base substances generated by an electrochemical reactor. The RO unit converts seawater into usable freshwater but generates a high-salt brine byproduct. The electrochemical reactor removes salt from the brine byproduct and the resulting reduced-salt stream is mixed with the seawater to form a feedwater stream supplied to the RO unit. The removed salt is converted into acid and base substances that are concentrated in separate product streams and utilized to automatically adjust a pH level of the feedwater stream in response to changes in the seawater chemistry of the seawater, thereby improving the RO unit's operating efficiency. The base product stream may also be used for ocean alkalinity enhancement (OAE), and the acid product stream may also be used to reduce energy costs associated with crushing/grinding alkaline rock in an enhanced ocean weathering (EOW) process.

### RELATED APPLICATIONS/PATENTS

This application is a continuation-in-part claiming priority from U.S. application Ser. No. 19/092,576, entitled “INTEGRATED OCEAN ALKALINITY ENHANCEMENT & SEAWATER DESALINATION”, filed on Mar. 27, 2025, which claims priority from U.S. Provisional Patent Application No. 63/716,029, entitled “INTEGRATED OCEAN ALKALINITY ENHANCEMENT & SEAWATER DESALINATION”, filed on Nov. 4, 2024, which is entirely incorporated herein by reference, and also claims priority from U.S. Provisional Patent Application No. 63/641,910, entitled “ELECTROCHEMICAL ASSISTED OCEAN WEATHERING”, filed on May 2, 2024, which is entirely incorporated herein by reference.

### FIELD OF THE INVENTION

The invention generally relates to desalination systems/methods that separate saltwater into freshwater and brine and to carbon dioxide removal systems/methods.

### BACKGROUND

As humans burn more and more fossil fuels, the resulting increased carbon dioxide (CO₂) concentration in Earth's atmosphere causes both climate change and ocean acidification. The increased atmospheric concentrations of CO₂ and other greenhouse gases (e.g., methane) produces climate change by trapping heat close to earth's surface, thereby increasing both air and sea temperatures. Because earth's oceans absorb about 25% of atmospheric CO₂, and because the absorbed CO₂ dissolves to form carbonic acid that remains trapped in the seawater, the increased atmospheric CO₂ concentration caused by burning fossil fuels also produces ocean acidification by way of increasing the amount of CO₂ gas dissolved in the ocean.

Both climate change and ocean acidification pose significant threats to humans. Climate change in the form of increased global average temperatures can produce several dangerous effects such as the loss of polar ice and corresponding increased sea levels, disease, wildfires and stronger storms and hurricanes. Ocean acidification changes the ocean chemistry that most marine organisms rely on. One concern with ocean acidification is that the decreased seawater pH can lead to the decreased survival of shellfish and other aquatic life having calcium carbonate shells, as well as some other physiological challenges for marine organisms.

To avoid dangerous climate change, the international Paris Agreement aims to limit the increase in global average temperature to no more than 1.5° C. to 2° C. above the temperatures of the pre-industrial era. Global average temperatures have already increased by between 0.8° C. and 1.2° C. The Intergovernmental Panel on Climate Change (IPCC) estimates that a ‘carbon budget’ of about 500 GtCO₂ (billion tons of carbon dioxide), which corresponds to about ten years at current emission rates, provides a 66% chance of limiting climate change to 1.5° C.

In addition to cutting CO₂ emissions by curtailing the use of fossil fuels, climate models predict that a significant deployment of Negative Emissions Technologies (NETs) will be needed to avoid catastrophic ocean acidification and global warming beyond 1.5° C. (see “Biophysical and economic limits to negative CO₂ emissions”, Smith P. et al., Nat. Clim. Chang. 6016; 6: 42-50). Current atmospheric CO₂ and other greenhouse gas concentrations are already at dangerous levels, so even a drastic reduction in greenhouse gas emissions would merely curtail further increases, not reduce atmospheric greenhouse gas concentrations to safe levels. Moreover, the reduction or elimination of certain greenhouse gas sources (e.g., emissions from long-distance airliners) would be extremely disruptive and/or expensive and are therefore unlikely to occur soon.

Therefore, there is a need to supplement emission reductions with the deployment of NETs, which are systems/processes that serve to reduce existing atmospheric greenhouse gas concentrations by, for example, capturing/removing CO₂ from the air and sequestering it for at least 1,000 years. The need for NETs may be explained using a bathtub analogy in which atmospheric CO₂ is represented by water contained in a bathtub, ongoing CO₂ emissions are represented by water flowing into the tub, and NETs are represented by processes that control water outflow through the tub's drain. In this analogy, reduced CO₂ emission rates are represented by partially turning off the water inflow tap—the slower inflow rate provides more time before the tub fills, but the tub's water level will continue to rise and eventually overflow. Using this analogy, although reducing CO₂ emissions may slow the increase of greenhouse gas in the atmosphere, critical concentration levels will eventually be reached unless NETs are implemented that can offset the reduced CO₂ emission level (i.e., remove atmospheric CO₂ at the same rate it is being emitted). Moreover, because greenhouse gas concentrations are already at dangerous levels (i.e., the tub is already dangerously full), there is an urgent need for NETs that are capable of significantly reducing atmospheric CO₂ faster than it is being emitted to achieve safe atmospheric concentration levels (i.e., outflow from the tub's drain must be greater than the reduced inflow from the tap to reduce the tub's water to a safe level).

NETs can be broadly characterized as Direct Air Capture (DAC) approaches and Ocean Capture approaches. DAC approaches utilize natural (e.g., reforestation) and technology-based methods to extract CO₂ directly from the atmosphere. Ocean capture approaches utilize various natural and/or technological processes to remove CO₂ from the atmosphere and store it in the ocean as bicarbonate, a form of carbon storage that is stable for over 10,000 years.

Electrochemical ocean alkalinity enhancement (electrochemical OAE or EOAE) represents an especially promising ocean capture approach that both reduces atmospheric CO₂ and mitigates ocean acidification by generating an ocean alkalinity product (i.e., an aqueous alkaline solution containing a fully dissolved base substance) and supplying the ocean alkalinity product to ocean seawater at a designated outfall location. Electrochemical OAE systems typically generate the required base substance using an electrochemical reactor referred to as a bipolar electrodialysis device (BPED), which generally includes an electrodialysis (ED) apparatus and associated flow control devices configured to perform an electrochemical salt-conversion process that converts salt supplied in an aqueous salt feedstock solution (e.g., seawater) into the base substance and an acid substance. The base substance produced by the BPED is then incorporated into the ocean alkalinity (base) product that is then supplied to the ocean. As the base substance diffuses (disperses) into the surrounding seawater it serves to directly reverse ocean acidification (i.e., by utilizing the base substance in the ocean alkalinity product to increases the ocean seawater's alkalinity), and indirectly reduces atmospheric CO₂ (i.e., increasing the ocean seawater's alkalinity increases the ocean's ability to absorb/capture atmospheric CO₂). Moreover, because the generated base substance is fully dissolved in the ocean alkalinity product, the electrochemical OAE approach avoids problems associated with other OAE approaches (e.g., dissolution kinetics issues that are associated with conventional mineral OAE approaches).

Although electrochemical OAE approaches show great potential in mankind's efforts to combat global warming and ocean acidification, their widespread acceptance as a suitable NET may be predicated on the continued development of OAE system features that minimize cost per unit of captured/removed atmospheric CO₂ (LCOC). For economic reasons related to carbon offsets and trading, NETs having relatively low LCOC ratings are typically favored over NETs exhibiting relatively high LCOCs. When calculating a NET's LCOC rating, many factors are taken into consideration, including capital costs (e.g., construction and installation expenses), and ongoing operating costs (e.g., land, water, maintenance, and electrical power expenses). In the case of OAE systems, the amount of atmospheric carbon removed from the atmosphere over an ocean depends on the amount of base substance supplied to the ocean (i.e., by way of the ocean alkalinity product), whereby the LCOC of an OAE system is predominantly determined by its levelized cost of producing each unit of base substance. In terms of the capital cost components of LCOC, OAE systems have an advantage over many NETs in that OAE systems are relatively inexpensive to construct and install, have a relatively small footprint and can be controlled using automated operating systems. Moreover, due to the high energy consumption and wear-related part replacement costs associated with performing the electrochemical salt-conversion process (described above), the most significant operating costs associated with an OAE system arise in the operation of the OAE system's BPED. Therefore, developments that reduce BPED operating costs arguably provide the most promising way to reduce OAE system LCOC.

The BPEDs currently utilized in OAE systems are referred to herein as 3-chamber BPEDs for brevity. Such 3-chamber BPEDs may be characterized by utilizing an electrodialysis apparatus having an ion exchange (IE) stack configured in a 3-chamber cell arrangement, and by utilizing a flow control system capable of directing three different aqueous solutions (i.e., a salt feedstock solution, an acid solution, and a base solution) through corresponding salt/acid/base chambers of the IE stack. The IE stack includes multiple 3-chamber cells arranged in series between opposing electrodes, where each 3-chamber cell includes salt, acid and base chambers that respectively serve as parallel flow channels for the aqueous salt, acid and base solutions as they pass through the IE stack (i.e., each cell includes a salt chamber that channels a portion of the salt feedstock solution, an acid chamber that channels a portion of the aqueous acid solution, and a salt/base chamber that channels a portion of the base solution). Each cell's salt chamber is disposed between and separated from the cell's acid and salt/base chambers by corresponding ion exchange membranes, which are configured to facilitate the transfer of sodium and chloride ions from the salt chamber into the base and acid chambers during the electrochemical process. That is, during the electrochemical process an electric field applied across the IE stack by the electrodes produces an ionic current in a direction perpendicular to the parallel flow paths, whereby anions in the salt/base/acid streams (e.g., chloride ions (Cl⁻) and hydroxide ions (OH⁻)) move toward the positive electrode (anode) and cations in the salt/base/acid streams (e.g., sodium ions (Na⁺) and protons (H⁺)) move toward the positive electrode (anode). This ionic current causes dissociated salt molecules (i.e., sodium ions (Na⁺) and chloride ions (Cl⁻)) to exit the salt feedstock stream in opposite directions (i.e., such that the chloride ions (Cl⁻) pass through a first ion exchange filter from the cell's salt chamber into the cell's acid chamber, and the sodium ions (Na⁺) pass through a second ion exchange filter into the acid chamber). The chloride ions (Cl⁻) then combine with protons (H⁺) to form “new” acid (HCl) molecules in the acid solution stream passing through each cell's acid chamber, and the sodium ions (Na⁺) combine with hydroxide ions (OH⁻) to form “new” base (NaOH) molecules in the base solution stream passing through each cell's salt/base chamber. As a result of this electrochemical salt-conversion process, the base solution exiting (i.e., flowing out of) the IE stack, which combines the base solution flows exiting each of the cells, has a significantly higher concentration of base substance (e.g., NaOH molecules) than before entering the IE stack. Similarly, the acid solution exiting each cell has a higher concentration of acid substance (e.g., HCl molecules) than before entering the IE stack. That is, the 3-chamber IE stack arrangement is configured such that three separate streams exit the ED apparatus: a reduced-salt solution stream (i.e., having a lower salt content than the salt feedstock solution fed into the ED apparatus), an acid product (strong acid) stream including the “new” acid molecules, and a base product (strong base) stream including the “new” base molecules.

The main operational costs associated with 3-chamber BPEDs include the cost of externally supplied electricity and maintenance (e.g., replacement part and manual labor) associated with the IE stack, flow control system and other BPED subsystems required to perform the electrochemical salt-conversion process. A majority of the externally supplied electricity needed to power a given BPED operations is consumed by the IE stack (i.e., to generate the electric field that produces the ionic current) and varies in accordance with the BPED's IE stack arrangement. That is, larger capacity IE stacks (i.e., those capable of generating larger amounts of base substance per hour) typically require a larger number of series-connected cells. Although the salt/acid/base solutions are conductive, each ion exchange membranes functions like a resistor that impedes the applied electric field. Therefore, larger capacity IE stacks require larger amounts of externally supplied electricity to maintain an electric field at a suitably strong level across a larger number of cells (i.e., across a larger number of ion exchange membranes) than that required by smaller capacity IE stacks. Moreover, a significant amount is needed to power the flow control system (e.g., the various pumps and valves required to maintain the pressures and flow rates of the salt/acid/base solution streams) and other BPED subsystems, such as feedstock pretreatment units that are typically utilized to remove solids and other contaminants (e.g., divalent ions) from the aqueous salt feedstock solution (e.g., seawater) in order to reduce fouling (e.g., mineral scaling) in the IE stack. BPED maintenance costs include the cost of replacing parts that periodically wear out during normal BPED operations, costs associated with service/labor required to replace these parts, and costs associated with maintenance-related downtime (i.e., the periods of OAE system non-operation that are required to perform maintenance operations). Similar to the cost of externally supplied electricity, maintenance costs are typically higher for BPEDs with larger capacity IE stacks than BPEDs with lower capacity IE stacks due to the need to periodically replace a greater number of expensive ion exchange membranes and the higher expense associated with the replacement of flow control system and pretreatment unit components capable of the required higher flow capacities. Because the effectiveness of OAE systems as a NET is strongly dependent on minimizing LCOC (i.e., minimizing the levelized cost of producing base substance), and because the cost of externally supplied electricity and maintenance costs (e.g., the cost of ion exchange filters/membrane replacement) represent two of the most significant expenses associated with an OAE system's production of base substance, there is a strong motivation to optimize OAE system operations in a way that minimizes these two cost components.

Enhanced ocean weathering (EOW) represents another promising ocean capture approach that both reduces atmospheric CO₂ and mitigates ocean acidification. EOW involves spreading finely ground alkaline aggregate (e.g., silicate rock, such as basalt) onto large ocean surface areas. The widely dispersed alkaline aggregate captures large amounts of dissolved CO₂ while in contact with the ocean water. The alkaline aggregate then sinks below the surface, thereby storing the captured CO₂ in the ocean and slowing ocean acidification by way of direct interaction between the ocean's seawater and the alkaline material. A major challenge faced by EOW technologies is how to maximize CO₂ drawdown for a given amount of finely ground alkaline aggregate. Currently, the best strategies for addressing this challenge at scale involve crushing/grinding the alkaline rock into extremely small particles and then dispersing these particles over large areas of the ocean to maximize the ratio of surface area to dispersed volume. A problem with these EOW strategies is that both the crushing/grinding and dispersing processes require a significant amount of energy. As explained above, the effectiveness of EOW systems as a NET is strongly dependent on minimizing LCOC, and because the cost of externally supplied electricity to crush/grind the alkaline rock represents one of the most significant expenses associated with an EOW system, there is a strong motivation to optimize EOW system operations in a way that minimizes this cost component.

Seawater desalination is the process of removing salt and other contaminants from seawater, making it suitable for human consumption, irrigation, or industrial uses. Seawater desalination allows coastal communities to use a broader variety of water sources than conventional techniques, improving the resilience of water-stressed communities. Seawater desalination will become increasingly important as climate change threatens traditional water resources. As sea levels rise, existing freshwater aquifers for coastal communities are at an increasingly high risk of seawater intrusion, thereby making seawater desalination an important potential tool to help these communities adjust to climate change.

Seawater desalination systems utilize either thermal technologies or membrane-based technologies. Thermal desalination systems heat seawater so that H₂O evaporates into steam, leaving behind salt and other impurities, then condenses the steam back into liquid freshwater that is suitable for human consumption or other freshwater uses. Membrane-based desalination describes a class of technologies in which saline water passes through a semi-permeable material that allows H₂O through but holds back dissolved solids like salts. Seawater reverse osmosis (SWRO) is the most common membrane-based desalination technology that utilizes reverse-osmosis (RO) to reverse the natural osmosis process (i.e., the natural movement of freshwater from an area of low salt concentration to an area of high salt concentration) by utilizing high-energy pumps to pressurize seawater located on a first side of a semi-permeable material such that passes through the membrane to generate freshwater (sometimes referred to as permeate) on the opposing (second) side of the membrane and leaving behind high-salt content brine (i.e., aqueous solution having a significantly higher salt content than that of seawater) on the first side of the membrane. Note that the pressure required to force a feedstock solution through a membrane is directly proportional to the feedstock solution's salt content (i.e., saltier water having a relatively high salt concentration requires more pressure than less salty water), but this pressure is limited by the strength of the membrane (i.e., the membrane will rupture if the pressure is too high). Therefore, the strength of the membrane effectively creates an upper limit on the salinity of water that can be treated at a given flow volume, and a feedstock solution having a salt content much higher than seawater typically cannot be purified using reverse osmosis technologies.

Problems associated with all seawater desalination technologies are related to the disposition of brine, high operating costs and carbon footprint. Both thermal and membrane-based desalination technologies generate brine having a higher salt concentration than seawater that is typically disposed of by supplying the brine into the ocean in a manner that both avoids ecological hazards (e.g., harm to sea life) and does not increase the salt content of the seawater feedstock drawn into the desalination plant (i.e., significant resources are required to disperse the brine over a large ocean region and far from the seawater feedstock input pipe). In addition, although the most efficient thermal desalination processes typically use more energy than membrane-based approaches, even SWRO desalination consumes large amounts of electrical energy (e.g., to drive seawater feed pumps and to achieve the pressures necessary to force permeate through semi-permeable membranes). This high energy consumption causes conventional SWRO desalination plants to have both high operating costs and a large carbon footprint (i.e., due to the significant greenhouse gas emissions associated with the generation of the required electrical energy). This energy usage is a leading cost driver as well as can limit project capacities based on energy availability. Lowering the energy input leads to significant project upside.

What is needed is a SWRO system/method that reduces desalination system operating costs (i.e., external electricity and/or maintenance) and greenhouse gas emissions while avoiding the ecological hazards and other problems associated with brine disposition.

### SUMMARY OF INVENTION

The present invention is directed to a modified seawater reverse-osmosis (SWRO) desalination system and associated method that utilize an electrochemical reactor, a mixing device and a controller to enhance the operating efficiency of a reverse-osmosis (RO) unit in a way that reduces desalination system operating costs and greenhouse gas emissions while avoiding the ecological hazards and other problems associated with brine disposition. Similar to conventional SWRO desalination systems, the RO unit generates a freshwater stream by utilizing a high-pressure pump to force seawater (i.e., as part of a feedwater stream, described below) through a membrane assembly to divert (separate) salt (i.e., NaCl molecules and other salts/ions/substances present in seawater) into a high-salt brine (byproduct) stream, where the operating efficiency of the RO unit can be expressed by a ratio of freshwater production (e.g., the volumetric flow rate of the freshwater stream) divided by the power (amount of electrical energy) required for the high-pressure pump to force the feedwater stream through the membrane assembly. The electrochemical reactor receives the high-salt brine stream from the RO unit and converts (processes) salt contained in the high-salt brine stream into an acid substance and a base substance, the conversion process being performed such that most of the acid substance is transferred from the brine stream into an acid product (second) stream and most of the base substance is transferred from the brine stream into a base product (third) stream, whereby a reduced-salt stream exiting the electrochemical reactor (i.e., the high-salt brine stream after the conversion/removal of salt) has a (third) salt concentration that is less than the (first) salt concentration of the seawater. By utilizing the electrochemical reactor to remove/convert salt from the high-salt brine stream in this manner, the modified seawater desalination system significantly reduces the ecological hazards and other problems associated with brine disposition in conventional seawater desalination systems. Moreover, diverting the base and acid substances into separate product streams facilitates utilizing these substances for a variety of beneficial purposes (e.g., adjust a pH level of the feedwater stream, facilitate OAE operations, and/or for commercial sale or otherwise utilized to reduce total system operating costs). The mixing device is configured to generate the feedwater stream supplied (e.g., by way of the high-pressure pump) into the membrane assembly of the RO unit by way of mixing (e.g., using a valve or a mixing tank) a stream of raw or treated seawater from an ocean with the reduced-salt stream generated by the electrochemical reactor. This arrangement reduces operating costs over conventional (seawater only) SWRO desalination system approaches by effectively recycling the portion of seawater required to form the high-salt brine stream (note that this seawater portion is typically discarded in conventional SWRO systems), thereby reducing total energy costs by reducing the amount of seawater that must be pumped from an ocean. In addition, because the salt content of the reduced-salt stream is far below that of the seawater, the feedwater stream effectively dilutes the seawater (i.e., the seawater/reduced-salt-stream mixture has a lower salt concentration than that of the raw/treated seawater), thereby further reducing total energy costs by reducing the amount of energy required for high-pressure pump to generate sufficient pump pressure to force the feedwater stream through the membrane assembly of the RO unit. According to an aspect, the modified SWRO system/method further reduces operating costs by selectively utilizing the acid and base substances generated by the electrochemical reactor to automatically adjust a pH level of the feedwater stream in response to changes in the seawater chemistry of the seawater processed by the RO unit. This aspect recognizes that the operating efficiency of conventional SWRO systems is related to periodic changes in seawater chemistry, particularly ionic composition and pH, which can vary significantly over time (e.g., seasonally) in ways that directly influences the osmotic pressure, membrane scaling tendencies, and recovery rate of the RO unit, thereby conventional SWRO systems consume significantly more energy than during periods when the seawater remains at or close to the selected pH level. As mentioned above energy usage is a leading cost driver in seawater desalination systems, so the additional energy consumption required during these periods of less efficient RO unit operation can significantly affect the decision to implement an SWRO plant. The present invention avoids these periods of less efficient operation by providing a control system (e.g., a controller and a network of sensors and signal lines) that is operably configured to: determine (identify) a target feedwater pH level; utilize the target feedwater pH level and an updated/current seawater pH level to determine a target reduced-salt pH level; and control the electrochemical reactor and/or the mixing device to modifying a concentration of acid substance or base substance contained in the reduced-salt stream until a current reduced-salt pH level of the modified reduced-salt stream is equal to the target reduced-salt pH level, whereby subsequent combining (mixing) of the modified reduced-salt stream and the seawater produces the feedwater stream with a feedwater pH level that is equal to the target feedwater stream pH level. By utilizing the acid and base products generated by the electrochemical reactor to modify (adjust) the feedwater pH level to equal the target feedwater stream pH level in this way, the present invention provides a system/method for automatically maintaining the RO unit's operating efficiency at an optimal level even when changes in seawater chemistry cause significant variation in the seawater's pH level, thereby significantly reducing energy costs (and, hence, total operating costs) in comparison with conventional SWRO systems.

In an exemplary embodiment an integrated (combined) desalination/OAE system includes a seawater desalination subsystem and an OAE subsystem (electrochemical reactor). The seawater desalination subsystem generates a freshwater stream by desalinating seawater pumped or otherwise drawn from a nearby ocean using the reverse-osmosis desalination processes mentioned above. The OAE subsystem includes an ED apparatus that converts salt provided in the byproduct brine stream from the desalination process into acid and base substances that are concentrated in corresponding product streams. The system also includes a post-production unit that selectively utilizes a portion of the base product stream to generate an ocean alkalinity product and selectively utilizes a portion of the acid product stream to generate an alkaline slurry, and then supplies (e.g., pumps) the ocean alkalinity product and the alkaline slurry to the ocean at a designated outfall location for OAE and enhanced ocean weathering (EOW) purposes (i.e., such that both the fully dissolved base substance in the ocean alkalinity product and the etched/weakened alkaline aggregate capture/reduce atmospheric carbon dioxide and mitigate ocean acidification). Integrating seawater desalination and at least one of OAE or EOW operations in the manner set forth herein essentially eliminates the ecological concerns associated with conventional stand-alone seawater desalination and significantly decreases total operating costs (i.e., in comparison with conventional stand-alone seawater desalination and OAE systems).

Although described herein with reference to specific modified desalination and integrated desalination/OAE/EOW systems/methods, the present invention may also be utilized to provide other commercially advantageous operations that may achieve at least some of the benefits set forth above. For example, the present invention may be utilized to maximize the operating efficiency of seawater desalination systems utilizing multi-pass and/or multi-stage reverse osmosis arrangements.

### BRIEF DESCRIPTION OF THE DRAWINGS

FIG. 1 shows a modified SWRO system according to an exemplary embodiment of the present invention;

FIG. 2A is a flow diagram showing a method for utilizing acid and base substances generated by the electrochemical reactor of the SWRO system of FIG. 1 to improve an operating efficiency of the reverse osmosis unit of the electrochemical reactor of FIG. 1 according to an exemplary embodiment;

2B is a flow diagram showing a method for utilizing acid and base substances to improve a reverse osmosis unit's operating efficiency according to another exemplary embodiment meth

FIG. 3 shows a simplified electrochemical reactor that may be utilized to electrochemically process a brine solution in the modified SWRO system of FIG. 1 according to an exemplary specific embodiment;

FIG. 4 shows a simplified electrodialysis apparatus that may be utilized by the electrochemical reactor of FIG. 3 to electrochemically convert salt into acid and base products according to another exemplary embodiment;

FIG. 5 shows an integrated desalination/OAE/EOW system according to another exemplary embodiment of the present invention;

FIG. 6 shows an EOW subsystem of the integrated desalination/OAE/EOW system of FIG. 5 in additional detail according to an exemplary embodiment; and

FIG. 7 shows a partial modified SWRO system including a multi-pass reverse osmosis arrangement according to another exemplary embodiment of the present invention.

### DETAILED DESCRIPTION

The present invention combines desalination and electrochemical systems/processes in a way that converts seawater into freshwater suitable for human consumption and other freshwater uses, a base substance suitable for OAE purposes, and an acid substance suitable for EOW purposes. The invention is primarily described herein with specific reference to a modified desalination system/method that utilizes a desalination subsystem/process to convert feedwater (i.e., a saline solution at least partially comprising seawater) into freshwater and brine and utilizes an electrochemical reactor/process to convert the brine into a reduced salt solution (i.e., by converting salt in the brine into acid and base substances). In one embodiment the invention is described with reference to an integrated desalination/OAE/EOW system/method that desalinates seawater to produces freshwater and brine, electrochemically processes the brine to generate acid and base products, utilizes the base product to perform an OAE process, and utilizes the acid product to reduce the energy costs associated with crushing/grinding alkaline aggregate in an EOW process. However, in some embodiments the systems/methods described herein may be utilized for other purposes, including a system/method for generating acid and/or base substances in remote locations. The following description is presented to enable one of ordinary skill in the art to make and use the methods and systems described herein as provided in the context of specific embodiments. Various modifications to the embodiments will be apparent to those with skill in the art, and the general principles defined herein may be applied to other embodiments. Therefore, the methods and systems described herein are not intended to be limited to the particular embodiments shown and described but are to be accorded the widest scope consistent with the principles and novel features herein disclosed.

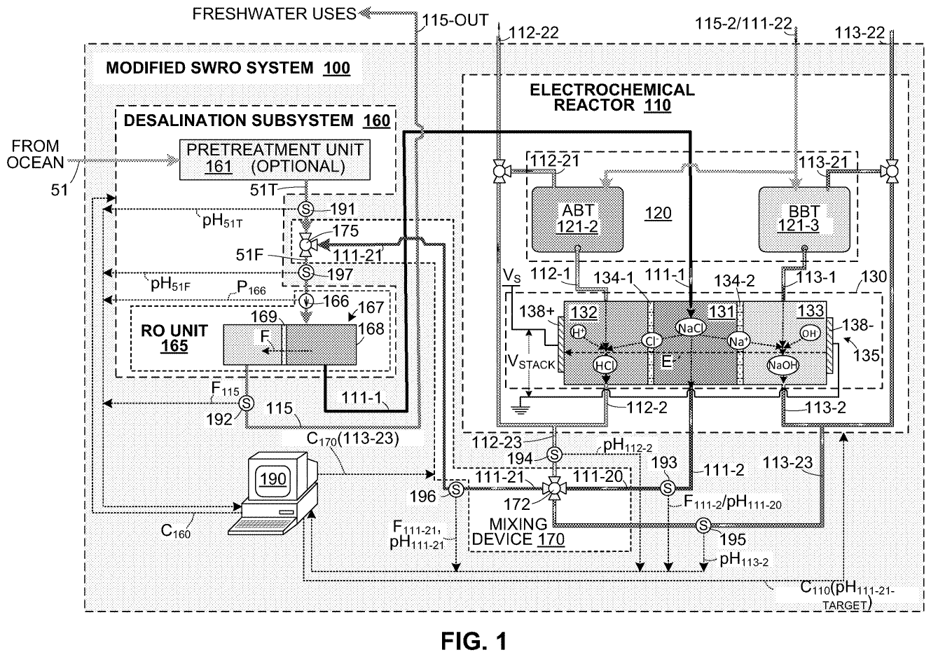

FIG. 1 depicts a modified desalination system 100 including an electrochemical reactor 110, a desalination subsystem 160 including at least one reverse-osmosis (RO) units 165, a mixing device 170 and a control system including a system controller 190, multiple sensors 191-197 and corresponding data and control signal lines. Electrochemical reactor 110 performs an electrochemical process in which a high-salt-content brine stream 111-1 is received from the desalination subsystem 160, salt contained in brine stream 111-1 is electrochemically processed (converted into acid and base substances), and then at least a portion 111-21 of the resulting reduced-salt stream 111-2 is directed back to desalination subsystem 160 by way of mixing device 170. Mixing device 170 modifies (i.e., in accordance with control signals C₁₇₀ received from controller 190) a concentration of either the acid substance or the base substance contained in reduced-salt stream portion 111-21 received from electrochemical reactor 110, and then mixes (combines) a seawater stream 51T (e.g., raw or treated seawater) with reduced-salt stream portion 111-21 to form a feedwater stream 51F that is supplied to RO unit 165. RO unit 165 processes (desalinates) feedwater stream 51F to generate a freshwater “product” stream 115 (i.e., water suitable for human consumption, irrigation, or industrial uses) and brine “byproduct” stream 111-1, which is directed to electrochemical reactor 110. System controller 190 controls the various operations performed by electrochemical reactor 110, desalination subsystem 160 and mixing device 170 such that at least a portion of freshwater 115 exiting desalination subsystem 160 is directed out of system 100 as freshwater output stream 115-OUT for fresh water uses. Additional details regarding the various components and processes of system 100 are set forth below.

Referring to the left side of FIG. 1, desalination subsystem 160 includes an optional pretreatment unit 161 and a reverse-osmosis (RO) unit 165.

Optional pretreatment unit 161 is configured to treat a raw seawater stream 51 (i.e., seawater pumped or otherwise received directly from an ocean) by removing (e.g., filtering) solids and other contaminants (e.g., biological material and/or divalent ions) from the raw seawater. The resulting treated seawater stream 51T exiting pretreatment unit 165 is then supplied to mixing device 170. Note that optional pretreatment unit 161 does not significantly reduce or otherwise change the salt content of the seawater (i.e., the treated seawater forming seawater stream 51T has substantially the same initial (first) salt concentration as that of raw seawater stream 51. Pretreatment unit 161 may be omitted, for example, is cases where raw seawater stream 51 is sufficiently pure (i.e., free of contaminants), or in embodiments where seawater stream 51 is treated prior to being delivered into desalination subsystem 160. When pretreatment unit 161 is omitted, raw seawater is passed directly to mixing device 170 (i.e., treated seawater stream 51T and raw seawater stream 51 comprise the same seawater chemistry).

Mixing device 170 includes a first mixing element (e.g., a four-way valve) 172 and a second mixing element (e.g., a three-way valve) 175. As described in additional detail below, mixing element 172 functions to modify a concentration of either the acid substance or the base substance contained in reduced-salt stream 111-2 received from electrochemical reactor 110, and to pass the pH modified reduced-salt stream 111-21 to mixing element 175. Mixing element 175 is configured to receive pH modified reduced-salt stream portion 111-21 from mixing element 172 and treated seawater stream 51T from pretreatment unit 165, and utilizes a suitable mechanism (e.g., one or more valves, a mixing tank and/or pumps) to mix (combine) the two streams and to produce a feedwater (mixture) stream 51F including a aqueous saline solution having a (fourth) salt concentration that is between the initial (first) salt concentration of seawater stream 51T and an intermediate (third) salt concentration of reduced-salt stream 111-21. As described in additional detail below, electrochemical reactor 110 is configured to generate reduced-salt stream 111-2 such that the intermediate (third) salt concentration of reduced-salt stream 111-21 is lower than the initial (first) salt concentration of seawater stream 51T. Therefore, feedwater stream 51F comprises an aqueous solution having a salt concentration that is lower than the (first) salt concentration of the seawater. An outlet of mixing element 175 is operably coupled to an inlet of RO unit 165 such that feedwater stream 51F is directed into (supplied to) RO unit 165.

In some embodiments mixing element 175 is configured to generate feedwater stream 51F by combining all of reduced-salt stream 111-21 received from electrochemical reactor 110 with a corresponding portion of the treated/untreated seawater included in seawater stream 51T. That is, the flow rate of feedwater stream 51F exiting mixing element 175 is substantially equal to a sum of the inflow rate of reduced-salt stream 111-21 received from electrochemical reactor 110 and the inflow rate of seawater stream 51T (i.e., feedwater stream 51F is at least partially formed by (includes) seawater stream 51T). In this preferred embodiment, feedwater stream 51F includes the total amount of reduced-salt stream 111-21 received from electrochemical reactor 110 and adjusts, if necessary, the inflow rate of seawater stream 51T (e.g., by way of a valve or other flow control device). For example, assuming desalination unit 180 is configured to process feedwater stream 51F at a total flow rate of 100 units per minute, if electrochemical reactor 110 provides reduced-salt stream 111-21 to mixing device 170 at an inflow rate of 30 units/min then the corresponding inflow rate of treated seawater stream 51T is adjusted to equal 70 units/min, and if electrochemical reactor 110 subsequently provides reduced-salt stream 111-21 at an inflow rate of 35 units/min then the corresponding inflow rate of treated seawater stream 51T is adjusted to 65 units/min. Utilizing all of the available reduced-salt stream 111-21 to generate feedwater stream 51F minimizes the amount of salt that must be removed from feedwater stream 51F by RO unit 165 (i.e., by minimizing the proportion of seawater to reduced-salt solution in feedwater stream 51F). Note that variations in the inflow rate of reduced-salt stream 111-21 may occur for purposes of project wide optimization. For example, when acid production is valued higher than freshwater and base production, then a freshwater stream portion 115-2 (i.e., a diverted portion of freshwater stream 115-OUT) may be directed to acid buffer tank 121-2 (i.e., to increase the value of acid product stream 112-2 by minimizing salt content), whereby more of reduced-salt stream 111-2 may be directed to mixing device 170 as reduced-salt stream portion 111-21. In other cases it may be determined that freshwater and/or base production may be optimized when both freshwater stream portion 115-2 and a reduced-salt stream 111-22 (i.e., a diverted portion of reduced-salt stream 111-2) are simultaneously directed to acid buffer tank 121-2 and/or base buffer tank 121-3, where the system controller adjusts the fractions of the freshwater and reduced-salt streams to optimize the salt content in the acid and base solutions. In other embodiments, system optimization may be achieved by replenishing (making-up) for the acid product stream 112-22 and/or base product stream 113-22 using only reduced-salt stream portion 111-22 with the remainder of reduced-salt stream 111-2 being directed to mixing device 170 as reduced-salt stream portion 111-21. Whenever system optimization requires a corresponding change (increase/decrease) in the inflow rate of salt stream portion 111-21 to mixing element 175, the system controller makes a corresponding adjustment (decrease/increase) to the inflow rate of seawater stream 51T so that the outflow rate of feedwater stream 51F remains constant.

Similar to conventional SWRO desalination systems, RO unit 165 includes a high-pressure pump 166 and a membrane assembly 167 including a pressure vessel 168 containing a semi-permeable membrane 169. The high-pressure pump 166 is configured to force feedwater stream 51F through pressure vessel 168. Semi-permeable membrane 169 is configured to permit the passage of water molecules (H₂O) but to resist the passage of salt molecules (e.g., NaCl), whereby salt is diverted (separated) from freshwater stream 115 by way of collecting on one side of membrane 169 while freshwater stream passes through membrane 169 (as indicated by dotted-line-arrow F). The diverted salt is subsequently removed from membrane assembly 165 by way of high-salt brine (byproduct) stream 111-1, which is formed by a small portion of feedwater stream 51F. Similar to conventional SWRO desalination systems, freshwater stream 115 generated by RO unit 165 comprises an aqueous solution having a suitably low salt concentration (e.g., 500 ppm or less), and brine stream 111-1 comprises an aqueous saline solution having (second) salt concentration above 50,000 ppm (5%), which is greater than the (first) salt concentration of the seawater (e.g., approximately 35,000 ppm). Also similar to conventional SWRO desalination systems, an operating efficiency of RO unit 165 can be expressed by a ratio of freshwater production (e.g., a volumetric flow rate F₁₁₅ of freshwater stream 115, as measured by a suitable sensor 197) divided by the power P₁₆₆ (amount of electrical energy) consumed by high-pressure pump 166 when forcing feedwater stream 51F through membrane assembly 167.

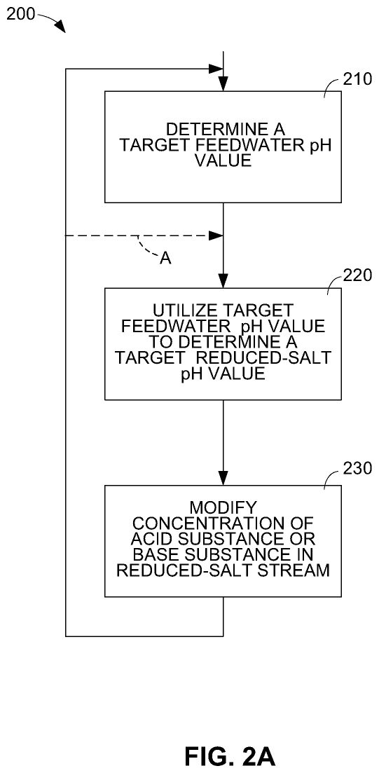

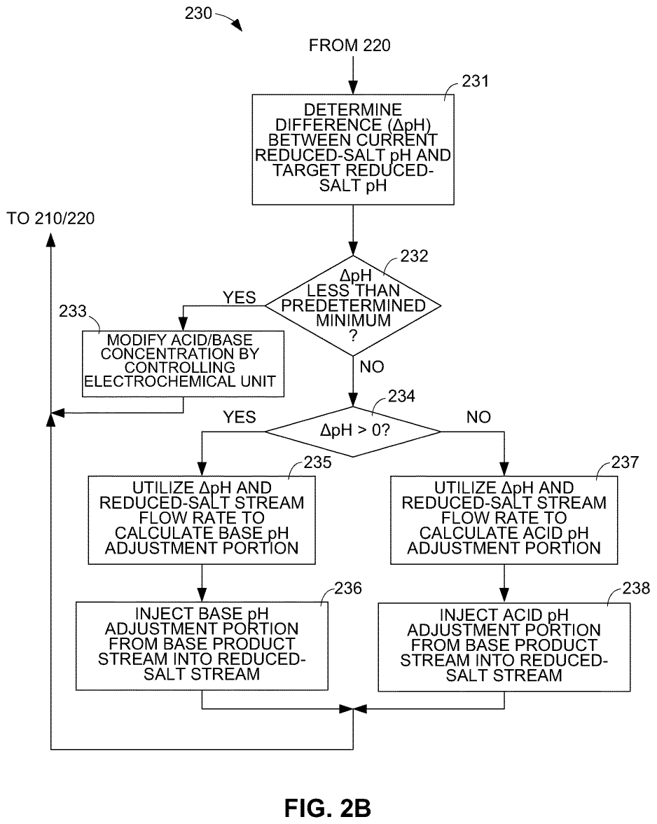

Referring to the right side of FIG. 1, electrochemical reactor 110 includes a fluid buffering system 120, an electrochemical reactor 130 and a flow control system. As set forth in additional detail below, electrochemical reactor 110 is configured to generate reduced-salt stream 111-2 by electrochemically processing brine stream 111-1 such that at least some of the salt molecules (e.g., NaCl) contained in brine stream 111-1 are converted into acid molecules (e.g., HCl) contained in an acid product stream 112-2 and base molecules (NaOH) contained in a base product stream 113-2, and such that the reduced-salt stream 111-2 exiting the electrochemical reactor 110 has a relatively low (third) salt concentration that is lower than the initial (first) salt concentration of the seawater contained in seawater stream 51T. Note that electrochemical reactor 110 is greatly simplified for descriptive purposes, and that additional details regarding its construction and operation are provided below with reference to the exemplary embodiments depicted in FIGS. 2 to 5.

Fluid buffering system 120 includes an acid buffer tank (ABT) 121-2 and a base buffer tank 121-3. Acid buffer tank 121-2 is configured to contain an aqueous acid solution that is circulated through reactor 130 by way of associated flow control structures (e.g., pipes and pumps) such that a relatively weak acid stream 112-1 is directed from acid buffer tank 121-2 to reactor 130 and at least a portion (recycle fraction) 112-21 of a relatively strong acid product stream 112-2 leaving reactor 130 is directed back to acid buffer tank 121-2. Base buffer tank 121-3 is configured to contain an aqueous base solution that is circulated through reactor 130 by way of associated flow control structures such that a relatively weak base stream 113-1 is directed from base buffer tank 121-3 to reactor 130 and at least a portion (recycle fraction) 113-21 of a relatively strong base product stream 113-2 leaving reactor 130 is directed back to base buffer tank 121-3. In some embodiments, the flow control system is further configured to direct a portion 115-2 of freshwater 115 into one or more of acid buffer tank 121-2 and base buffer tank 121-3 to dilute the weak solutions directed into reactor 130.

ED apparatus 130 generally includes an ion exchange (IE) stack 135 that is disposed between two electrodes (i.e., anode 138+ and cathode 138−). IE stack 135 typically includes multiple cells arranged in series between electrodes 138+ and 138−, where each cell includes three chambers that respectively serve as parallel flow channels for the aqueous salt, acid and base solutions as they pass through IE stack 135. For brevity and clarity, only one cell of IE 135 is depicted in FIG. 1, which is made up of a salt chamber 131 that functions to channel a portion of the aqueous salt solution, an acid chamber 132 that channels a portion of the aqueous acid solution, and a base chamber 133 that channels a portion of the aqueous base solution. Each cell's salt chamber 131 is disposed between and separated from the cell's acid chamber 132 and base chamber 133 by corresponding ion exchange membranes 134-1 and 134-2, which are configured to facilitate the transfer of sodium and chloride ions from the salt chamber into the base and acid chambers during the electrochemical process as described below. ED apparatus 130 also includes manifold or other structures (not shown) that are configured to cooperate with the flow control resources of BPED 110 to direct the three different (i.e., a salt, acid and base) aqueous solutions through corresponding salt/acid/base chambers of IE stack 135. Specifically, the aqueous salt solution enters IE stack 135 as brine stream 111-1 that is divided and directed (e.g., by an input manifold, not shown) into the inlet of each cell's salt flow channel 131, and the aqueous salt solution exits the IE stack 135 by way of an outlet of each cell's salt flow channel 131 (and an outlet manifold, not shown) as reduced-salt stream 111-2. Similarly, the aqueous acid solution enters IE stack 135 as a weak acid stream 112-1 that is directed into the inlet of each cell's acid flow channel 132 and exits the IE stack 135 by way of an outlet of each cell's acid flow channel 132 as acid product stream 112-2. Finally, the aqueous base solution enters IE stack 135 as a weak base stream 113-1 that is directed into the inlet of each cell's base flow channel 133 and exits the IE stack 135 by way of an outlet of each cell's base flow channel 133 as base product stream 113-2.

During the electrochemical process the three (salt, acid and base) aqueous solutions are directed through IE stack 135 along parallel flow paths (e.g., in the vertical direction) while a stack voltage V_{STACK} is applied to electrodes 138+ and 138−. When stack voltage V_{STACK} is sufficiently strong, the resulting electric field E produces an ionic current across IE stack 135 in a direction perpendicular to the parallel flow paths (e.g., in the horizontal direction). This ionic current causes dissociated salt molecules (i.e., sodium ions (Na⁺) and chloride ions (Cl⁻)) to exit brine stream 111-1 in opposite directions (i.e., such that the chloride ions (Cl⁻) pass through ion exchange filter 138-1 from salt chamber 131 into the acid chamber 132, and the sodium ions (Na⁺) pass through ion exchange filter 138-2 into base chamber 133). The chloride ions (Cl⁻) then combine with protons (H⁺) to form “new” acid molecules (HCl) in the acid solution stream flowing through acid chamber 132, and the sodium ions (Na⁺) combine with hydroxide ions (OH⁻) to form “new” base molecules (NaOH) in the base solution stream flowing through base chamber 133. As a result of this electrochemical salt-conversion process, base product stream 113-2 exits each cell's base chamber 133 with a significantly higher concentration of base molecules than weak base stream 113-1 (i.e., the aqueous base solution before it enters IE stack 135). Similarly, acid product stream 112-2 exiting each cell's acid chamber 132 has a higher concentration of acid molecules than that of weak acid stream 112-1. Note that, because salt is converted (consumed) to generate the acid and base molecules, reduced-salt stream 111-2 exiting each cell's salt chamber 131 has a lower salt concentration than inflowing brine stream 111-1.

Referring to the lower left portion of FIG. 1, system controller 190 controls the various operations performed by electrochemical reactor 110 by way of operation/control signals C₁₁₀, controls the various operations performed by desalination subsystem 160 way of operation/control signals C₁₆₀ such that at least a portion of the freshwater 115 exiting desalination unit 180 is directed out of system 100 as freshwater output stream 115-OUT, and controls mixing device 170 by way of control signals C₁₇₀ to facilitate modifying the pH level of reduced-salt stream portion 111-21 in the manner described below with reference to FIG. 2A. In an embodiment system controller 190 controls the operating state of ED apparatus 130 such that the above-described electrochemical process is performed at a rate that converts/removes a sufficient amount salt from brine stream 111-1 such that reduced-salt stream 111-2 leaving electrochemical reactor 110 has a relatively low (third) salt concentration that is lower than the initial (first) salt concentration of the seawater. In some embodiments system controller 190 controls a flow rate of feedwater stream 51F into RO unit 160 using sensor data from one or more sensors 196 configured to measure the flow rate F₁₁₁₋₂₁ of reduced-salt stream portion 111-21 (i.e., some or all of reduced-salt stream 111-2) from electrochemical reactor 110 into mixing element 175 and using a flow control device (e.g., pump or valve) to control the associated flow rate of seawater stream 51T into mixing element 175. Note that, because the salt concentration of reduced-salt stream 111-2 is lower than the initial (first) salt concentration of seawater stream 51/51T, any non-zero flow rate of reduced-salt stream portion 111-21 into mixing element 175 causes the solution forming feedwater stream 51F to have a (fourth) salt concentration that is lower than the initial (first) salt concentration of seawater stream 51/51T. Therefore, although operational and maintenance costs associated with desalination subsystem 160 may be reduced by way of directing all (i.e., the totality of) reduced-salt stream 111-2 from ED apparatus 130 to mixing device 170, beneficial reductions in total system operating costs may be achieved when reduced-salt stream portion 111-21 includes less than all of reduced-salt stream 111-2, and the remaining portion is redirected for other purposes (e.g., reduced-salt stream portion 111-22 may be used in place of or in combination with freshwater portion 115-2 to replenish (make-up) the acid and base solutions stored in buffer tanks 121-2 and 121-3). In some embodiments, system controller 190 is implemented using one or more processors configured to implement a software-based control algorithm that utilizes one of a proportional integral derivative, machine learning and/or artificial intelligence to coordinate the desalination and OAE processes (described below). In some embodiments controller 190 controls the operations performed by electrochemical reactor 110 to perform additional functions described in co-owned U.S. Pat. No. 11,629,067, entitled OCEAN ALKALINITY SYSTEM AND METHOD FOR CAPTURING ATMOSPHERIC CARBON DIOXIDE, which is incorporated herein by reference in its entirety.

According to an aspect of the present invention, the control system of modified SWRO system 100 is configured to further reduce total system operating costs by utilizing the acid and base substances generated by electrochemical reactor 110 to automatically adjust a pH level of feedwater stream 51F in response to changes in the seawater chemistry of seawater stream 51T in order to maximize the operating efficiency of RO unit 165. That is, the operating efficiency of conventional SWRO systems changes in response to normal periodic (e.g., seasonal) changes in seawater chemistry. In particular, variations in the ionic composition and pH of seawater can directly influence operating efficiency by changing the osmotic pressure, membrane scaling tendencies, and recovery rate of RO unit 165. Conventional SWRO systems are typically configured to operate at high efficiency when the supplied seawater has a “normal” chemistry (e.g., when the pH of the supplied with seawater remains at or close to a selected pH level, such as pH 7.5) and tend to operate less efficiently whenever the seawater's chemistry undergoes seasonal changes (e.g., when the seawater's pH increases above pH 7.5 or decreases below pH 7.5). During these periods of less efficient RO unit operation conventional SWRO systems consume significantly more energy than during periods when the seawater remains at or close to the normal pH level and RO unit 165 operates at or near optimal efficiency. As mentioned above (see Background paragraph 0016) energy usage is a leading cost driver in seawater desalination systems, so the additional energy consumption required during these periods of less efficient RO unit operation can significantly affect the decision to implement an SWRO plant. The present invention avoids these periods of less efficient RO unit operation by utilizing the acid and base substances generated by electrochemical reactor 110 to effectively compensate for changes in seawater chemistry by adjusting a pH level of reduced-salt stream portion 111-21 (e.g., pH value pH₁₁₁₋₂₁ measured by sensor 196) such that, when subsequently mixed/combined with seawater stream 51T, feedwater stream 51F is supplied to RO unit 165 with a pH level that optimizes operating efficiency. For example, when seasonal seawater chemistry changes cause the seawater pH level to increase above a “normal” pH level (e.g., when a series of pH values pH_{51T} measured over a period of time by sensor 191 indicate an increase in seawater pH level from pH 7.5 to pH 7.7), the concentration of acid substance in reduced-salt stream portion 111-21 is automatically increased by an amount such that, when modified (pH adjusted) reduced-salt stream portion 111-21 is subsequently mixed with seawater stream 51T, the resulting feedwater stream's pH level (value pH_{51F} measured by sensor 197) is equal to the target pH level of pH 7.5 (i.e., the pH level at which RO unit 165 processes feedwater stream 51F at a high/optimal operating efficiency). Conversely, when seasonal seawater chemistry changes cause seawater pH level to become too low for optimal efficiency (e.g., when measured seawater pH value pH_{51T} decreases from pH 7.5 to pH 7.3), the concentration of base substance in reduced-salt stream 111-2 is automatically increased such that, when modified (pH adjusted) reduced-salt stream 111-21 is subsequently mixed with seawater stream 51T, the resulting feedwater stream's pH level (value pH_{51F}) is equal to the target pH level of pH 7.5. By utilizing the acid and base substances generated by electrochemical reactor 110 to maximize the operating efficiency of RO unit 165 in this way, modified SWRO desalination system 100 produces freshwater at a significantly lower energy cost than is achievable by conventional SWRO systems.

FIG. 2A depicts a method 200 for utilizing the acid and base substances generated by electrochemical reactor 110 (FIG. 1) to maximize the operating efficiency of RO unit 165 according to an exemplary embodiment. In one embodiment method 200 may be implemented by the control system of modified SWRO system 100 (i.e., controller 190, a sensor network including sensors 191 to 197 and computer-controllable elements provided in electrochemical reactor 110 and/or mixing device 170) and is therefore described below with exemplary reference to modified SWRO system 100. Referring to block 210 at the top of FIG. 2A, controller 190 determines (identifies) a target feedwater pH value pH_{51F-TARGET}(e.g., a feedwater pH level at which RO unit 160 is known to operate with high or optimal efficiency) using one of the processes described below. Next, (block 220) controller 190 utilizes target feedwater pH value pH_{51F-TARGET} to determine a target reduced-salt pH value pH_{111-21-TARGET}, and then (block 230) controller 190 controls electrochemical reactor 110 and/or mixing device 170 (e.g., by way of generating and transmitting one or more of control signals C₁₁₀ and C₁₇₀) to modify a concentration of acid substance or base substance contained in modified reduced-salt stream portion 111-21 until a current reduced-salt pH level (e.g., value pH₁₁₁₋₂₁ measured by sensor 196) of modified reduced-salt stream portion 111-21 is equal to target reduced-salt pH level/value pH_{111-21-TARGET}. When the pH modified reduced-salt steam 111-21 (i.e., having reduced-salt pH level/value pH₁₁₁₋₂₁ equal to target reduced-salt pH level/value pH_{111-21-TARGET}) is subsequently combined with seawater stream 51T (e.g., by way of valve 175 or a mixing tank), the resulting feedwater stream 51F is generated with a feedwater pH level/value pH_{51F} that is equal to target feedwater stream pH level/value pH_{51F-TARGET}, whereby subsequent processing of feedwater stream 51F by RO unit 165 is performed at a high/optimized operating efficiency. As indicated by the arrow returning from block 230 to block 210, method 200 is repeated after each cycle in accordance with a selected systematic schedule. Additional details regarding method 200 are provided in the following paragraphs.

As mentioned above, various processes may be utilized to determine target feedwater pH level/value pH_{51F-TARGET} (block 210). In an exemplary embodiment one or more sensors 191 are operably positioned to access treated seawater stream 51T (i.e., before the seawater is combined with modified reduced-salt stream portion 111-21) and configured/utilized to systematically (periodically or continuously) generate seawater chemistry data values (e.g., pH_{51T} and/or ionic composition information) in a form that can be transmitted and interpreted by controller 190. Upon receiving each systematically generated seawater chemistry value, controller 190 utilizes a control algorithm (e.g., lookup table, machine learning or artificial intelligence (AI) engine) that is configured to identify (e.g., using previously stored data) a corresponding target feedwater pH level/value pH_{51F-TARGET} at which an operating efficiency of reverse osmosis unit 165 is optimized for each systematically generated seawater chemistry value.

In addition to (or as an alternative to) changes in seawater chemistry, other measured parameters may be utilized to determine systematically generated target feedwater pH levels/values pH_{51F-TARGET} (block 210). For example, target feedwater pH levels/values pH_{51F-TARGET} may be systematically updated in response to detected changes in the operating efficiency of RO unit 165. In one embodiment, the controller 190 may determine the operating efficiency of RO unit 165 at predetermined intervals, where an operating efficiency value quantifying the RO unit's operating efficiency at each given point in time is determined using a ratio of a flux value F₁₁₅ (e.g., as measured by one or more sensors 192 that indicates a current volumetric flow rate of freshwater stream 115) divided by a power consumption value P₁₆₆ (e.g., indicating the rate of energy consumption by high-pressure pump 166 in forcing feedwater stream 51F through pressure vessel 167). By comparing each operating efficiency value with previous operating efficiency values, controller 190 may detect changes in the operating efficiency of RO unit 165 caused by non-seawater-chemistry-related issues, such as scaling of membrane 169. When such a change in operating efficiency is detected, controller 190 may utilize a control algorithm (e.g., lookup table, machine learning, AI) to determine a corresponding target feedwater pH level at which operating efficiency of the reverse osmosis unit is optimized. This alternative approach facilitates response to non-seawater-chemistry changes (e.g., changes in the permeability of membrane 169) that may serve to improve RO unit operating efficiency and may be used in combination with the seawater chemistry approach. In yet another possible alternative approach, target feedwater pH value pH_{51F-TARGET} may be a predetermined value (e.g., a mean value determined using historic or experimental data prior to SWRO system operation) that remains constant throughout operation. In this case, the operation of block 210 is performed only once, and control returns from block 230 to block 220, as indicated by dashed-line-arrow A. Although the use of target feedwater pH value pH_{51F-TARGET} as a predetermined constant value may not provide optimal RO unit operating efficiency during some operating periods (i.e., in comparison to the alternatives mentioned above), this approach still allows for pH modifications to reduced-salt stream in response to changes in seawater pH value pH_{51T} or changes in RO unit operating efficiency, thereby providing an improvement over conventional SWRO desalination systems.

Referring again to block 220 (FIG. 2A), determining each target reduced-salt pH value pH_{111-21-TARGET} may involve calculating a difference between target feedwater pH level/value pH_{51F-TARGET} and a current seawater pH level (e.g., value pH_{51T} generated by sensor 191). In one embodiment, each systematically generated target feedwater pH level/value pH_{51F-TARGET} is matched with a corresponding current seawater pH value pH_{51T}, where each target feedwater pH level/value pH_{51F-TARGET} and its corresponding current seawater pH value pH_{51T} are generated concurrently (or within a few seconds of each other). In some embodiments, seawater chemistry data is systematically generated by sensor(s) 191, where the seawater chemistry data generated at a given point in time includes a corresponding seawater pH value pH_{51T} indicating the pH level of seawater stream 51T at that given point in time. Target reduced-salt pH values pH_{111-21-TARGET} may be systematically generated for each given point in time by calculating or otherwise determining a difference between each current seawater pH value pH_{51T} and target feedwater pH value pH_{51F-TARGET} at that point in time.

FIG. 2B is a flow diagram depicting a method for adjusting reduced-salt stream pH leve (block 230 in FIG. 2A) according to an exemplary embodiment.

Referring to block 231 (top of FIG. 2B), the method begins by determining a difference ΔpH between target reduced-salt pH level pH_{111-21-TARGET} (generated in block 220, FIG. 2A) and a current reduced-salt pH level pH₁₁₁₋₂₀ of salt stream 111-2 exiting the electrochemical reactor 110 (e.g., as measured by sensor 193 located near the output of ED apparatus 130). Note that difference ΔpH is introduced for purposes of describing the amount of acid/base modification implemented by exemplary method 230, and that the modification amount may be determined using other approaches.

Referring to decision block 232, difference ΔpH is utilized control whether the currently implemented acid/base modification will be performed by way of controlling electrochemical reactor 110 (YES branch from block 232) or by way of controlling mixing element 170 (NO branch from block 232). That is, when difference ΔpH is less than a predetermined amount, modifying the acid/base concentration contained in reduced-salt stream 111-2 exiting electrochemical reactor 110 is achieved by adjusting one or more operating parameters of electrochemical reactor 110 (e.g., one or more operating parameters associated with the operation of ED apparatus 130, fluid buffering system 120 and/or the flow control subsystem of reactor 110) such that a resulting adjusted reduced-salt pH level pH₁₁₁₋₂₀ of reduced-salt stream 111-2 exiting electrochemical reactor 110 is equal to target reduced-salt pH level pH_{111-21-TARGET}. Conversely, when difference ΔpH is greater than the predetermined amount, modifying the acid/base concentration of reduced-salt stream 111-2 is achieved by controlling valve 172 of mixing device 170 such that it injects either: (i) an acid pH adjustment portion 112-23 of from acid product stream 112-2, or (ii) a base pH adjustment portion 113-23 of base product stream 113-2 into reduced-salt stream 111-20 such that a resulting adjusted reduced-salt pH level pH₁₁₁₋₂₁ of modified reduced-salt stream portion 111-21 (i.e., the portion of reduced-salt stream 111-2 located downstream from valve 172) is equal to target reduced-salt pH level pH_{111-21-TARGET}. In the exemplary embodiment, “fine” modifications (i.e., relatively small changes) to the acid/base concentration of modified reduced-salt stream portion 111-21 are implemented by way of electrochemical reactor 110 when difference ΔpH is less than the predetermined minimum value, and “coarse” modifications (i.e., relatively large changes) to the acid/base concentration of modified reduced-salt stream portion 111-21 are implemented by way of mixing device 170 (e.g., by way of valve 172) when difference ΔpH is greater than a predetermined minimum value. Note that both coarse and fine acid/base concentration modifications may be implemented simultaneously. For example, during a first pass through method 200 (i.e., at a first time period) difference ΔpH may be greater than the predetermined minimum value, whereby mixing device 170 is controlled to modify the acid/base concentration of reduced-salt stream 111-2 by a coarse (relatively large) amount, and during a subsequent second pass (i.e., during a second time period when acid/base concentration of modified reduced-salt stream portion 111-21 by mixing device 170 is maintained), an updated difference ΔpH may be less than the predetermined minimum value, whereby electrochemical reactor 110 is controlled to modify the acid/base concentration of reduced-salt stream 111-2 by a fine (relatively small) amount, whereby modified reduced-salt stream portion 111-21 arriving at valve 175 includes both the coarse and fine modification amounts. Utilizing both coarse and fine modification approaches in this manner may facilitate precise adjustments to feedwater pH level pH_{51F} over a wide range of variations in seawater pH level pH_{51T}, thereby allowing modified SWRO system 100 to operate at a higher operating efficiency than if only one of the coarse or fine adjustments were utilized. However, significant beneficial reductions in total operating costs may be achieved by utilizing only one of the two approaches (i.e., acid/base modification either by way of mixing device 170 or by way of electrochemical reactor 110) to improve operational efficiency.

When difference ΔpH is less than the predetermined minimum value control passes along the YES branch from block 232 to block 233, and controller 190 controls electrochemical reactor 110 to perform a fine acid/base concentration modification by way of control signal C₁₁₀, which is modified to include values related to one or more of difference ΔpH and target reduced-salt pH level pH_{111-21-TARGET}. In particular, one or more subsystems of electrochemical reactor 110 (e.g., ED apparatus 130, fluid buffering system 120 and/or a flow control system) are operably controlled by way of control signal C₁₁₀ to increase either the acid concentration or the base concentration contained in reduced-salt stream 111-2 (e.g., by changing recycle fractions, circulating flow, or current utilized to control ED apparatus 130), whereby an initial reduced-salt stream pH level pH₁₁₁₋₂₀ of reduced-salt stream 111-2 exiting electrochemical reactor 110 is equal to target reduced-salt pH level pH_{111-21-TARGET}). For example, when difference ΔpH is equal to −0.5, controller 190 may control electrochemical reactor 110 in a way that increases the acid concentration contained in reduced-salt stream 111-2 by an amount that decreases a pH level of reduced-salt stream 111-2 by pH 0.5. In this case, controller 190 may control the flow control system of electrochemical reactor 110 in a way that increases the amount of acid recycle fraction 112-21 (i.e., the portion of acid product stream 112-2 returned to acid buffer tank 121-2) and/or decreases the amount of base recycle fraction 113-21 (i.e., the portion of base product stream 113-2 returned to base buffer tank 121-3), whereby the overall acidity within ED apparatus 130 (i.e., the acid concentration contained in reduced-salt stream 111-2) may be increased, where the applied acid/base recycle fraction change amounts cause the targeted pH 0.5 decrease (i.e., such that an initial reduced-salt stream pH level pH₁₁₁₋₂₀ of reduced-salt stream 111-2 exiting reactor 110 is equal to target reduced-salt pH level pH_{111-21-TARGET}). Conversely, when difference ΔpH is equal to +0.5, controller 190 may control the flow control system of electrochemical reactor 110 in a way that increases the amount of base recycle fraction 113-21 and/or decreases the amount of acid recycle fraction 112-21, whereby the overall acidity within ED apparatus 130 may be decreased (i.e., the base concentration contained in reduced-salt stream 111-2 may be increased) such that the pH level of reduced-salt stream 111-2 increases by pH 0.5.

When difference ΔpH is greater than the predetermined minimum value, control passes along the NO branch from decision block 232 to block 234 (FIG. 2B), where controller 190 determines whether to increase the acid concentration of reduced-salt stream 111-2 by way of injecting an acid pH adjustment portion 112-23 (i.e., a portion of acid product stream 112-2) or to increase the base concentration of reduced-salt stream 111-2 by way of injecting a base pH adjustment portion 113-23 (i.e., a portion of base product stream 113-2). In one embodiment, when an initial reduced-salt stream pH level pH₁₁₁₋₂₀ of an initial reduced-salt stream portion 111-20 (i.e., a section of reduced-salt stream 111-2 located between electrochemical reactor 110 and valve 172) is less than target reduced-salt pH level pH_{111-21-TARGET} (i.e., when ΔpH is greater than zero), then control passes along the YES branch from decision block 234 to block 235 and the base concentration of reduced-salt stream 111-21 is increased by way of injecting base pH adjustment portion 113-23 as described below with reference to blocks 235 and 236. Conversely, when initial reduced-salt stream pH level pH₁₁₁₋₂₀ of reduced-salt stream portion 111-20 is less than target reduced-salt pH level pH_{111-21-TARGET} (i.e., when ΔpH is less than zero), then control passes along the NO branch from decision block 234 to block 237 and the acid concentration of reduced-salt stream 111-21 is increased by way of injecting acid pH adjustment portion 112-23 as described below with reference to blocks 237 and 238.

Referring to block 235 (FIG. 2B), the injection of base pH adjustment portion 113-23 begins by utilizing difference value ΔpH (i.e., the difference between target reduced-salt pH level pH_{111-21-TARGET} and an initial reduced-salt pH level pH₁₁₁₋₂₀), a flux (flow rate) F₁₁₁₋₂ of reduced-salt stream 111-2 and a pH level pH₁₁₃₋₂ of base product stream 113-2 to determine a magnitude (volumetric flow rate) of base pH adjustment portion 113-23 into reduced-salt stream portion 111-20. In the exemplary embodiment, controller 190 calculates the magnitude of base pH adjustment portion 113-23 using difference ΔpH, which is generated as described above, flux F₁₁₁₋₂ of reduced-salt stream 111-2, which is measured by way of sensor(s) 193, and pH level pH₁₁₁₋₂ of base product stream 113-2, which may be measured by sensor(s) 195. With these values, controller 190 utilizes known techniques to calculate base pH adjustment portion 113-23 (i.e., the amount of base product stream 113-2 that, when injected at valve 172, mixes with initial reduced-salt stream portion 111-20 to generate modified reduced-salt stream portion 111-21 having a pH level equal to target reduced-salt pH level pH_{111-21-TARGET}. Referring to block 236, valve(s) 172 of mixing device 170 is then controlled to transfer (inject) base pH adjustment portion 113-23 from base product stream 113-2 into reduced-salt stream 111-2 (e.g., by way of opening the lower entry port of valve(s) 172 by an amount that passes the calculated magnitude (flow rate) of base product stream 113-2 into reduced-salt stream 111-2). Note that valve(s) 172 is also controlled to isolate acid product stream 112-2 from reduced-salt stream 111-20 (e.g., by way of closing the upper entry port of valve(s) 172). In one embodiment, controller 190 controls valve(s) 172 to inject base pH adjustment portion 113-23 by way of a control signal C₁₇₀ that is modified to include signal values related to pH adjustment portion 113-23, thereby generating modified reduced-salt stream portion 111-21 having target reduced-salt pH level pH_{111-21-TARGET}.

The injection of acid pH adjustment portion 112-23 into reduced-salt stream 111-2 is performed in a manner similar to that described above with respect to the injection of base pH adjustment portion 113-23. Referring to block 237 (FIG. 2B), in the exemplary embodiment controller 190 calculates a magnitude of acid pH adjustment portion 112-23 using difference value ΔpH, flux (flow rate) F₁₁₁₋₂ of reduced-salt stream 111-2, and a pH level pH₁₁₂₋₂ of acid product stream 112-2, which may be measured by sensor(s) 194. Referring to block 236, valve(s) 172 of mixing device 170 is then controlled to transfer (inject) acid pH adjustment portion 112-23 from acid product stream 112-2 into reduced-salt stream 111-2 (e.g., by way of opening the upper entry port of valve(s) 172 by an amount that passes the calculated magnitude (flow rate) of acid product stream 112-2 into reduced-salt stream 111-2) while isolating reduced-salt stream 111-2 from base product stream 113-2 (e.g., by way of closing the lower entry port of valve(s) 172). In one embodiment, controller 190 controls valve(s) 172 to inject acid pH adjustment portion 112-23 by way of a control signal C₁₇₀ that is modified to include signal values related to acid pH adjustment portion 112-23, thereby generating modified reduced-salt stream portion 111-21 having target reduced-salt pH level pH_{111-21-TARGET}.

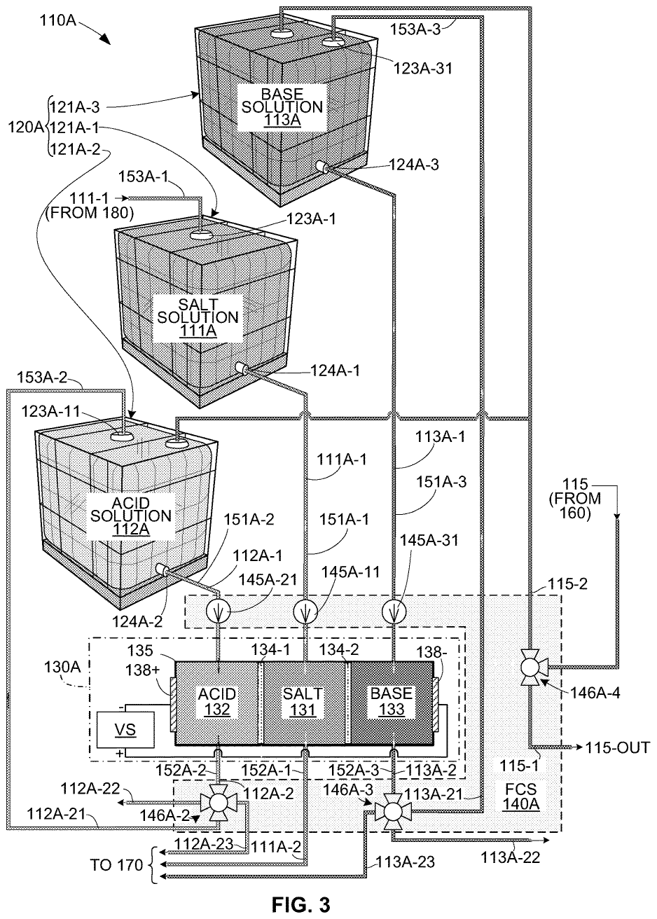

FIG. 3 shows a generalized bipolar electrodialysis (BPED) system (electrochemical reactor) 110A of a type similar to that utilized in some Ocean alkalinity enhancement (OAE) systems. BPED 110A generally includes a fluid buffering system 120A, an ED apparatus 130A, a flow control system 140A and a series of flow lines that are described in additional detail below. Additional details of BPED 110A are provided in U.S. Pat. No. 11,629,067, cited above.

Referring to the upper portion of FIG. 3, fluid buffering system 120A includes an optional salt buffer tank 121A-1 utilized to receive and store brine stream (salt solution) 111-1, an acid buffer tank 121A-2 utilized to store an acid solution 112A, and a base buffer tank 121A-3 utilized to store a base solution 113A. Each buffer tank 121A-1 to 121A-3 can be implemented using a standard 1000L IBC caged tote tank, where salt buffer tank 121A-1 includes a plastic containment unit 122A-1 having an inflow port 123A-1 operably coupled to receive brine stream 111-1 and an outflow port 124A-1 operably coupled to salt chamber(s) 131 of ion exchange stack 135, acid buffer tank 121A-2 includes a plastic containment unit 122A-2 having an inflow port 123A-21 operably coupled to receive acid product stream portion 112A-21 and an outflow port 124A-2 operably coupled to acid chamber(s) 132 of ion exchange stack 135, and base buffer tank 121A-3 includes a plastic containment unit 122A-3 having an inflow port 123A-31 operably coupled to receive base product stream portion 113A-21 and an outflow port 124A-3 operably coupled to base chamber(s) 133 of ion exchange stack 135. Portions of freshwater output stream 115 generated by desalination subsystem 160 (shown in FIG. 1) and/or portions of reduced-salt stream 111A-2 may be directed to buffering system 120A and utilized to dilute and maintain acid solution 111A and base solution 113A at suitable levels within buffer tanks 121A-2 and 121A-3.

Electrodialysis apparatus 130A includes ion exchange stack 135 and is otherwise configured and operates as described above with reference to FIG. 1 to electrochemical process NaCl (salt) molecules provided in brine stream 111A-1 such that Cl⁻ ions pass from salt chamber 131 though ion exchange membrane 134-1 into acid chamber 132 to enhance (i.e., decrease the pH of) acid solution 112A, and such that Na⁺ ions pass from salt chamber 131 though ion exchange membrane 134-2 into base chamber 133 to enhance (i.e., increase the pH of) base solution 113A. Ion exchange stack 135 can be surrounded by a water-tight containment housing (not shown) to facilitate the flow of salt solution 111A through salt chamber(s) 131, the flow of acid solution 112A through acid chamber(s) 132, and the flow of base solution 113A through base chamber(s) 133. Cathode 138Aand anode 138A+ are disposed at opposite ends of ion exchange stack 135 and generate an electric field through the chambers in response to an applied voltage differential provided by a suitable voltage source VS, thereby electrochemically processing the salt, acid and base streams in the manner described herein.

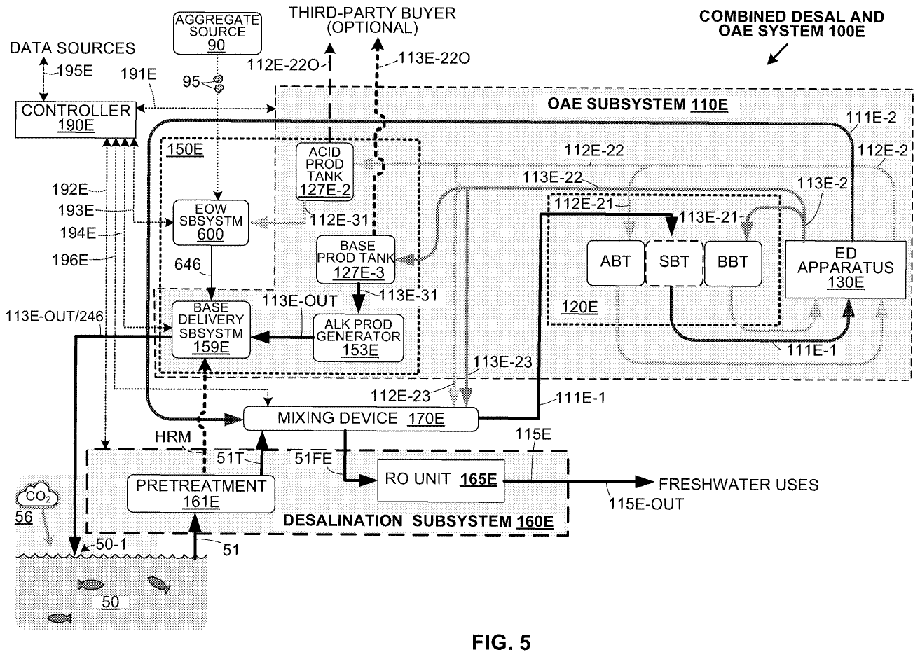

Similar to BPEDs utilized in OAE systems, flow control system 140A includes various control elements (e.g., pumps, valves etc.) that are collectively configured to direct streams of the acid and base solutions from buffer tanks 121A-2 and 121A-3 through corresponding chambers 132 and 133 of electrodialysis apparatus 130A and then back to buffer tanks 121A-2 to 121A-3 by way of associated conduits (flow lines). Specifically, weak acid stream 112A-1 exits acid buffer tank 121A-2 and is directed into acid chamber 132A by way of acid inflow line 1501A-2 and a pump 145A-21, and strong acid stream 112A-2 exits acid chamber 132A by way of acid outflow line 152A-2, with a first portion 112A-21 being returned to acid buffer tank 121A-2 by way of four-way valve 146A-2 and acid return line 153A-2, a second portion 112A-22 of strong acid stream 112A-2 being diverted out of BPED 110A, e.g., for system maintenance purposes or commercial sale, and a third (acid pH adjustment) portion 112A-23 being diverted to mixing device 170 (shown in FIG. 1). Similarly, weak base stream 113A-1 exits base buffer tank 121A-3 and is directed into base chamber 133A by way of base inflow line 151A-3 and a pump 145A-31, a portion 113A-21 of strong base stream 113A-2 exiting base chamber 133A by way of base outflow line 152A-3 is returned to base buffer tank 121A-3 by way of four-way valve 146A-3 and a base return line 153A-3, a second portion 113A-22 of strong base stream 113A-2 is diverted out of BPED 110A, e.g., for OAE purposes (e.g., as described below with reference to FIG. 5) or for commercial sale, and a third (base pH adjustment) portion 113A-23 being diverted to mixing device 170 (shown in FIG. 1).

BPED 110A differs from BPEDs typically utilized in OAE systems in that, unlike the acid and base solutions, flow control system 140A does not circulate all of the reduced-salt solution exiting ion exchange stack 135 back to the acid/base buffer tanks. Instead, flow control system 140A is configured to direct brine stream 111-1 into salt chamber(s) 131 and to direct at least a portion of reduced-salt stream 111A-2 from salt chamber(s) 131 to mixing device 170 (shown in FIG. 1). Flow control system 140A also includes an optional valve 146A-4 that controllable by the system controller to direct a first portion 115-1 of freshwater stream 115 (received from desalination unit 180, see FIG. 1) for use as freshwater output stream 115-OUT, and directs second portion 115-2 of freshwater stream 115 to buffering system 120A (i.e., into one or both of acid buffer tank 121A-2 and base buffer tank 121A-3 to replenish acid/base product diverted from electrochemical reactor 110A for other purposes). In some embodiments a portion of reduced-salt stream 111A-2 is directed to fluid buffering system 120A for similar reasons.

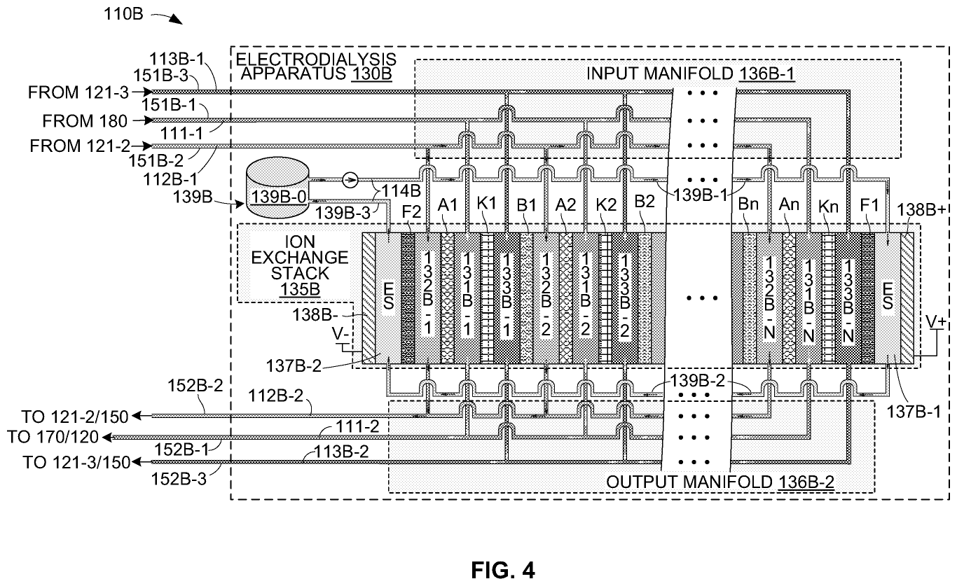

FIG. 4 shows a portion of a BPED system 110B including an ED apparatus 130B that includes an ion exchange stack 135B, an input manifold 136B-1, an output manifold 136B-2 and an electrolyte solution circulation system 139B. ED apparatus 130B may provide additional details regarding the multiple acid, salt and base chambers described above with reference to ED apparatus 130A (FIG. 3). That is, in some embodiments ED apparatus 130A (FIG. 3) is configured to include the features and details of ED apparatus 130B.

Ion exchange stack 135B includes multiple acid chambers 131B-1 to 131B-N, multiple salt chambers 132B-1 to 132B-N and multiple base chambers 133B-1 to 133B-N disposed in a repeating series of cells that are arranged in series between two end chambers 137B-1 and 137B-2. For example, a first cell in the series may include salt chamber 131B-1 disposed between associated acid chamber 132B-1 and associated base chamber 133B-1, and a last cell in the series may include salt chamber 131B-N disposed between associated acid chamber 132B-N and associated base chamber 133B-N. Each of the acid, salt and base chambers of ion exchange stack 135B may function as described above with reference to acid chamber 132, salt chamber 131 and base chamber 133, respectively, to process a corresponding portion of one of the acid, salt and base solution streams directed through ion exchange stack 134B by way of input manifold 136B-1 and output manifold 136B-2. That is, input manifold 136B-1 may split weak acid stream 112B-1 (which is received from an acid buffer tank (not shown) by way of acid inflow line 151B-2) such that corresponding portions of the acid stream pass through each acid chamber 131B-1 to 131B-N. Similarly, input manifold 136B-1 receives brine stream 111-1 by way of salt inflow line 151B-1 and splits brine stream 111-1 into multiple stream portions that are directed through salt chambers 131B-1 to 131B-N, and receives weak base stream 113B-1 from a base buffer tank (not shown) by way of base inflow line 151B-3 and splits weak base stream 113B-1 into multiple stream portions that are directed through base chambers 133B-1 to 133B-N. End chambers 137B-1 and 137B-2 may function to conduct an electrolyte solution indicated by “ES” for purposes described below.

Ion exchange stack 135B may include four types of ion permeable membranes that are respectively disposed between adjacent acid, salt, base and end chambers and facilitate the ion transfer process utilized to strengthen the base stream and the salt stream during operation of BPED 110B (i.e., when ion exchange stack 135B receives an electric field generated applying voltage potentials V+ and V− to anode 138B+ and cathode 138B−, respectively). The four types of membranes are indicated in FIG. 4 using the prefixes “A”, “K”, “B” and “F”, where membranes A1 to An are anion exchange membranes, membranes K1 to Kn are cation exchange membranes, membranes B1 to Bn are bipolar membranes, and membranes F1 and F2 are end membranes having characteristics described below. Electrolyte solution circulation system 139B may include a reservoir 139B-0 and flow lines 139B-1 to 139B-3 that function to circulate an electrolyte solution 114B through end chambers 137B-1 and 137B-2. That is, electrolyte solution 114B can be pumped from reservoir 139B-0 along first flow line 139B-1 to first end chamber 137B-1, from end chamber 137B-1 along second flow line 139B-2 to second end chamber 137B-2, and from second end chamber 137B-2 along third flow line 139B-3 to reservoir 139B-0. During operation the electrolyte solution may give up Na+ ions at one end of ion exchange stack 134B and reabsorbs Na+ ions at the opposing end of ion exchange stack 135B. In some embodiments, electrolyte solution 114B is implemented using sodium sulfate or a semi conductive solution such as sodium hydroxide.

FIG. 5 depicts a system 100E according to another embodiment. In the depicted embodiment, system 100E includes an OAE subsystem (electrochemical reactor) 110E, a seawater desalination subsystem 160E and an enhanced ocean weathering (EOW) subsystem 600, whereby system 100E is sometimes referred to herein as an integrated desalination/OAE/EOW system. However, in some embodiments EOW subsystem 600 may be omitted, whereby system 100E may be referred to as an integrated desalination/OAE system (i.e., by way of including OAE subsystem 110E and seawater desalination subsystem 160E). In other embodiments seawater desalination subsystem 160E may be omitted (e.g., seawater 51 is pumped directly to OAE subsystem 110E), whereby system 100E may be referred to as a hybrid CDR system for reasons that will become clear below. Therefore, although system 100E is depicted as an integrated desalination/OAE/EOW system, it is understood that FIG. 5 also shows an integrated desalination/OAE system and a hybrid CDR system.

Referring to desalination subsystem 160E (lower portion of FIG. 5), seawater 51 is pumped or otherwise transported from ocean 50 into a pretreatment unit 161E (e.g., a nanofiltration, ultrafiltration, chemical precipitation or other water purification system) that is configured to treat (i.e., remove contaminants from) seawater 51. Treated seawater 51T is then mixed with reduced-salt stream 111E-2 in mixing device 170E to form feedwater stream 51FE (i.e., a treated seawater/reduced-salt mixture solution), and then feedwater stream 51FE is processed by an RO unit 165E to generate freshwater stream 115E and byproduct brine stream 111E-1, whereby at least a portion of freshwater stream 115E is diverted out of system 100E as freshwater output stream 115E-OUT. Mixing device 170E is also configured to selectively inject either an acid pH adjustment portion 112E-23 of acid product stream 112E-2 or a base pH adjustment portion 113E-23 of base product stream 113E-2 into reduced-salt stream 111E-2 in the manner described above such that, when modified reduced-salt stream 111-23E is mixed with treated seawater stream 51T, feedwater stream 51FE has a pH level that optimizes an operating efficiency of RO unit 165E. In one embodiment, pretreatment unit 161E is configured to remove hardness related minerals HRM (along with other contaminants) such that a hardness of seawater 51 is reduced before being supplied to mixing device 170E. In some embodiments, as indicated by the dashed-line arrow, the hardness related minerals HRM are supplied to a post-production unit 150E and returned to ocean 50 with the ocean alkalinity product and/or alkaline slurry (both discussed below).

OAE subsystem 110E includes a fluid buffering system 120E, an ED apparatus 130E and a flow control system that are configured and operate in the manners described in at least one of the previously described embodiments. ED apparatus 130E converts salt provided in brine stream 111E-1 into acid molecules (e.g., HCl) disposed in an acid product stream 112E-2 and base molecules (e.g., NaOH) disposed in a base product stream 113E-2. Base buffer tank 120E includes an acid buffer tank (ABT) that receives a (first) portion 112E-21 of acid product stream 112E-2 and supplies a weak acid stream to ED apparatus 130E, a base buffer tank (BBT) that receives a (first) portion 113E-21 of base product stream 113E-2 and supplies a weak base stream to ED apparatus 130E, and an optional salt buffer tank (SBT) that receives brine stream 111E-1 from desalination unit 180E and supplied brine stream 111E-1 to ED apparatus 130E. Although not depicted in FIG. 5 for clarity, portions of reduced salt stream 111E-2 and/or freshwater stream 115E may be directed to acid buffer tank (ABT) and base buffer tank (BBT) for the make-up and dilution purposes discussed above.

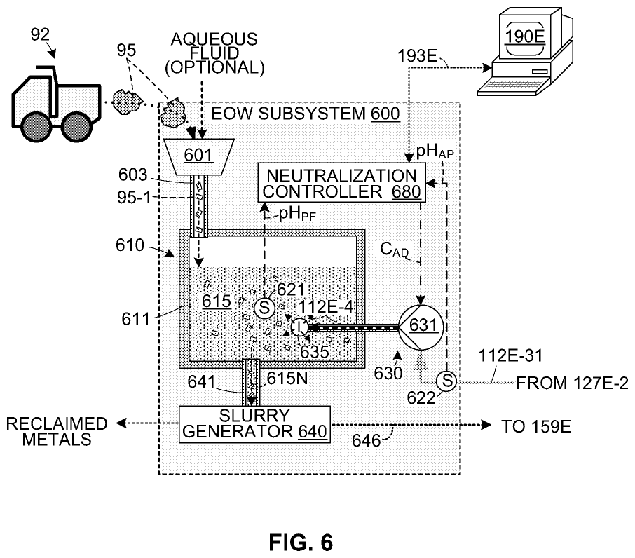

System 100E also includes a post-production unit 150E that selectively utilizes a portion 113E-22 of base product stream 113E-2 to generate an ocean alkalinity product 113E-OUT and selectively utilizes a portion 112E-22 of the acid product stream 112E-2 to generate an alkaline slurry 646, and then supplies (e.g., pumps) the ocean alkalinity product 113E-OUT and the alkaline slurry 646 to the ocean 50 at a designated outfall location 50-1 for OAE purposes (i.e., such that both the fully dissolved base substance in the ocean alkalinity product and the etched/weakened alkaline aggregate capture/reduce atmospheric carbon dioxide CO₂ and mitigate ocean acidification). In the exemplary embodiment, a portion of post-production unit 150E that is considered part of OAE subsystem 100E includes an acid product tank 127E-2, a base product tank 127E-3, an alkalinity product (ALK PROD) generator 153E and a base delivery subsystem 159E. Acid product tank 127E-2 receives and stores a portion 112E-22 of acid product stream 112E-2, and base product tank 127E-3 receives and stores a portion 113E-22 of base product stream 113E-2. Alkalinity product generation unit 153E is configured to generate an ocean alkalinity product 113E-OUT using a base product stream portion 113E-31, which is received from base product tank 127E-3, such that ocean alkalinity product 113E-OUT includes base molecules (NaOH) that are fully dissolved in a salt solution and has a pH level that is a predetermined amount higher than a pH level of the ocean's seawater 51 (e.g., in a target pH range between 8.0 and 9). In some embodiments the ocean alkalinity product 113E-OUT is generated using a dilution apparatus configured to operate in the manner described in co-owned and co-pending U.S. patent application Ser. No. 18/131,839, entitled “PRODUCTION EFFICIENCY OPTIMIZATION FOR BIPOLAR ELECTRODIALYSIS DEVICE”, which was filed on Apr. 6, 2023 and is incorporated herein by reference in its entirety. Post-production unit 150E also includes an enhanced ocean weathering (EOW) subsystem 600 that is configured to generate an alkaline slurry 646 using an acid product stream portion 112E-31, which is received from acid product tank 127E-2, by combining acid product stream portion 112-31 with a coarsely-ground alkaline aggregate (rock) such that a reaction between the alkaline aggregate and the acid molecule both neutralizes the acid molecules and etches/weakens the alkaline aggregate. Enhanced ocean weathering subsystem 600 is described in additional detail below with reference to FIG. 6. Base delivery subsystem 159E is configured and controlled by system controller 190E to supply (e.g., pump) at least one of ocean alkalinity product 113E-OUT and alkaline slurry 646 to ocean 50 at a designated outfall location 50-1.

System controller 190E is programmed and otherwise configured to control operations of OAE subsystem 110E by way of control signals 191E, to control operations of desalination subsystem 160E by way of control signals 192E, and configured to control operations of post-production unit 150E by way of control signals 193E and 194E such that one or both of alkalinity product 113E-OUT and alkaline slurry 646 are selectively supplied to ocean 50 in safe and efficient manner. In one embodiment, system controller 190E monitors sensors and other data sources (e.g., via data 195E) and controls base delivery system 159E by way of control signal 194E such that ocean alkalinity product 113E-OUT and alkaline slurry 646 are only supplied to ocean 50 when data 195E indicates that sea life adjacent to outfall location 50-1 will not be endangered by the release of these OAE substances. In another embodiment, system controller 190E may monitor one or more sites that provide input data 195E including spot pricing for the base product and/or acid product generated by electrochemical reactor 110E. Controller 190E may then utilize this input data to determine whether the base and/or acid products should be utilized for OAE/EOW purposes, or whether they should be sold to a third-party buyer. For example, when sufficient low/zero-carbon electricity is available from a power grid to offset the desalination process carbon footprint and the base product spot price is sufficiently high, then the controller 190E may direct the post-production unit 150E (e.g., by way of control signals 191E) to divert a base product portion 113E-220 (e.g., some or all of the second base stream portion 113E-22) for sale to a third-party buyer (i.e., instead of directing the base product to ocean 50 as part of ocean alkalinity product 113E-OUT), whereby proceeds from the sale serve to reduce total operating costs of system 100E. Similarly, the control algorithm implemented by system controller 190E may monitor input data 195E from one or more sites that provide spot pricing for the acid product (e.g., HCl), and utilizes this data to determine whether it is more cost effective to neutralize the acid product (e.g., by way of EOW subsystem 600), or if selling the acid product may produce a greater value (i.e., if the acid product spot price is sufficiently high), in which case the controller 190E may direct the post-production unit 150E to divert an acid product portion 112E-220 (e.g., some or all of the second acid stream portion 112E-22) for sale to a third-party buyer. In another embodiment, system controller 190E controls mixing device 170E by way of control signals 196E, for example, such that the selective injection of either acid pH adjustment portion 112E-23 or base pH adjustment portion 113E-23 into reduced-salt stream 111E-2 is controlled in accordance with control signals 196E.

FIG. 6 shows EOW subsystem 600 of integrated desalination/OAE/EOW system 100E (see FIG. 5) according to an exemplary embodiment. EOW subsystem 600 includes an accelerated ocean weathering reaction apparatus 610, a dosing apparatus 630, a slurry generator 640 and a neutralization controller 680. Accelerated ocean weathering reaction apparatus 610 includes a reaction tank 611 configured to contain a process fluid 615 including a mixture of alkaline aggregate 95 and acid product portion 112E-31 until the acid molecules are neutralized and alkaline aggregate 95 is etched/weakened. In some embodiments alkaline aggregate 95 may be transported from a quarry or other source by a material delivery vehicle 92 and processed by an optional pre-crusher/grinder 601 before the pre-crushed/ground alkaline aggregate 95-1 is delivered into reaction tank 611 by way of an inlet pipe 603. Dosing apparatus includes one or more dosing pumps 631 that receive acid product portion 112E-31 from acid product tank 127E-2 and is controlled by neutralization controller 680 to inject acid product doses 112E-4 into reaction tank 611 by way of an injector 635. Neutralization controller 680 controls the delivery/injection of alkaline aggregate and acid product into reaction tank 611 by way of monitoring a process fluid pH measurement data pH_{PF} generated by a first sensor 621 disposed inside reaction tank 611 and acid product pH measurement data pH_{AP} generated by a second sensor 622 disposed upstream from acid dosing pump(s) 631. During operation neutralization controller 680 controls the injection rate of acid product doses 112E-4 into reaction tank 611 such that a pH level of process fluid 615 is optimized such that acid molecules are neutralized and alkaline aggregate 95 is etched/weakened at a maximum rate. Neutralized product (i.e., a combination of neutralized acid solution and weakened/etched alkaline aggregate) is passed from reaction tank 611 to slurry generator 640 by way of an outlet pipe 641. Slurry generator 640 is configured to generate alkaline slurry 646 by processing (e.g., crushing/grinding) the etched/weakened alkaline aggregate of neutralized product 615N into fine particles, and then passes alkaline slurry 646 to base delivery subsystem 159E (see FIG. 5). In some embodiments, the accelerated weathering reaction causes the release of one or more metal elements (e.g., Nickel, Cobalt, Aluminum, Magnesium, Potassium and/or Lithium) from the alkaline aggregate and the slurry generator 640 is configured reclaim (i.e., separate and remove) the released metal elements from alkaline slurry 646 using known techniques, whereby system costs may be further reduced/offset by way of commercial sale of the reclaimed metals. In some embodiments the operation of EOW subsystem 600 is controlled by system controller 190E by way of control signals 193E passed to neutralization controller 680.

Referring again to FIG. 5, by configuring post-production unit 150E to implement both alkaline production generator 153E and EOW subsystem 600, system 100E implements a hybrid carbon dioxide removal (CDR) process and a reduced ocean acidification (ROA) process that combines some portions of each of a conventional electrochemical ocean alkalinity enhancement (EOAE) process and a conventional EOW process to achieve combined beneficial results (i.e., CDR/ROA-EOAE and CDR/ROA-EOW) achieved by both conventional processes, but changes other portions of each conventional processes in a way that reduces total operating costs (i.e., in comparison to separately performing the two conventional processes). For example, in one embodiment the hybrid CDR system implements the conventional EOAE process portions related to electrochemically processing salt to generate a base substance (e.g., NaOH) and an acid substance (e.g., HCl) and supplying the base substance to the ocean by way of an ocean alkalinity product, and the hybrid CDR system also implements the conventional EOW process portion related to mining and transporting alkaline aggregate/rock. The changes to the conventional EOAE and EOW processes occur after the acid byproduct is produced and after the alkaline rock is transported, whereby the conventional disposal of the acid byproduct and conventional crushing/grinding of the alkaline rock are replaced with an advanced weathering operation that includes combining alkaline rock and the acid product/substance generated by ED apparatus 130. In the embodiment described above with reference to FIG. 6, the advanced weathering operation involves mixing the acid product portion 112E-31 and alkaline rock/aggregate (e.g., olivine/basalt or other mafics/ultramafics) to produce alkaline slurry 646 with a pH between two and eight. As discussed above, slurry generation may include pre-grinding/crushing and/or post-reaction processing of the alkaline rock, but these optional processes require substantially less externally supplied energy than that required by the conventional crushing/grinding process and therefore costs less to perform than conventional acid disposal and crushing/grinding. During the advanced weathering operation, the acid substance in the acid byproduct reacts with alkaline substances in the alkaline rock, thereby weakening and/or increasing the surface area of the alkaline rock and neutralizing the acid substance. During the advanced weathering operation valuable and/or toxic metal constituents of the alkaline aggregate (Ni, Co, Al, Mg, K, Li, etc.) may be reclaimed from the slurry using known techniques. The advanced weathering process proceeds until the acid substance (e.g., HCl) supplied in the acid byproduct is neutralized, at which point the final alkaline slurry has a pH higher than ambient ocean pH (>7.5). The final alkaline slurry could then be dispersed into the ocean via fixed point (e.g., by way of base delivery subsystem 159E) or released from a moving vessel.

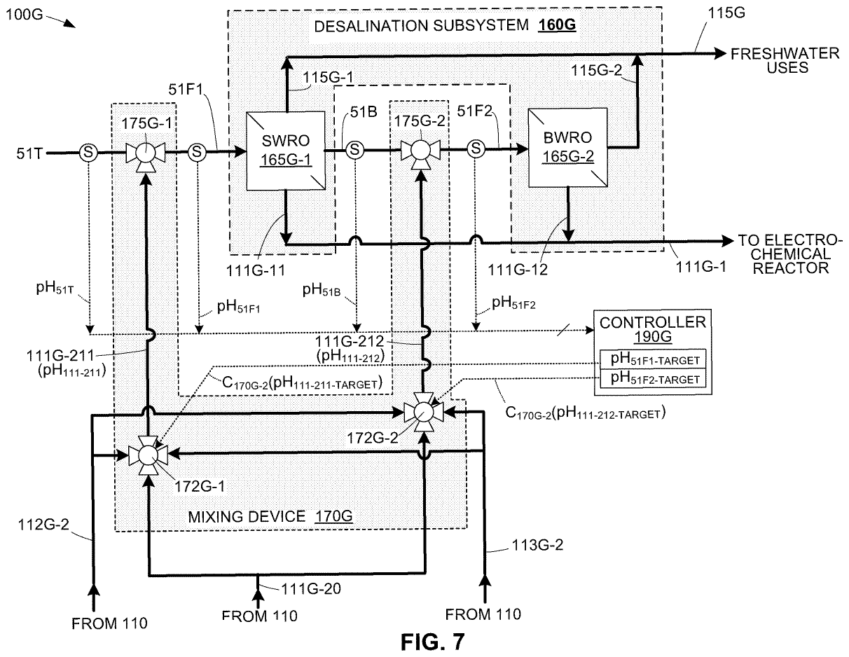

Although the invention is primarily described herein in the context of seawater desalination and seawater-based OAE systems/methods, various novel aspects described herein may be beneficially utilized in other systems/methods without departing from the spirit and scope of the invention. For example, although the seawater reverse-osmosis desalination method is described above with reference to systems utilizing single-stage RO configurations, the method may be beneficially utilized in systems that utilize multi-stage RO configurations, such as described below with reference to FIG. 7.

FIG. 7 shows a partial modified seawater desalination system 100G according to another exemplary embodiment in which method 200 (FIG. 2A) is implemented to enhance the operating efficiency of a two-pass RO arrangement. The portion of system 100G shown in FIG. 7 includes a desalination subsystem 160G, a mixing device 170G and a controller 190G, which are configured and operated as set forth below. Other devices and details of system 100G (including an electrochemical reactor) are understood to operate substantially as described in the exemplary embodiments set forth above and are therefore omitted for brevity and clarity.

Desalination subsystem 160G is configured and operates in a manner that is consistent with the exemplary embodiments set forth above in that it utilizes at least one RO unit (in this case, RO unit 165G-1 and RO unit 165G-2) to generate a freshwater stream 115G suitable for freshwater uses by diverting salt from a feedwater stream 51F1 that includes seawater 51T into a high-salt brine stream 111G-1. Desalination subsystem 160G differs from the exemplary embodiments set forth above in that, unlike the single-pass RO arrangements described above, desalination subsystem 160G includes a seawater (first) reverse-osmosis (SWRO) unit 165G-1 and a brackish water (second) reverse-osmosis (BWRO) unit 165G-2 configured in a two-pass RO arrangement (i.e., such that the reverse osmosis function performed by a single RO unit in the previous embodiments is collectively performed by SWRO unit 165G-1 and BWRO unit 165G-2). Each of SWRO unit 165G-1 and BWRO unit 165G-2 utilizes structures and membranes that are configured and operate in manners similar to those described above with reference to RO unit 165 or are otherwise known in the art and therefore details of these units are omitted for brevity. SWRO unit 165G-1 is configured to receive and process a first feedwater stream 51F1 including seawater 51T and to generate a brackish permeate stream 51B and a first high-salt brine stream portion 111G-11. In some embodiments, SWRO unit 165G-1 may also generate a relatively small (first) freshwater stream portion 115G-1. BWRO unit 165G-2 is configured to receive and process a second feedwater stream 51F2 including brackish permeate stream 51B and to generate a (second) freshwater stream portion 115G-2 and a second high-salt brine stream portion 111G-1G. In some embodiments, freshwater stream 115G is formed by combining freshwater stream portions 115G-1 and 115G-2, and in other embodiments may be formed entirely by freshwater stream portion 115G-2. High-salt brine stream (concentrate) 111G-1 is formed by combining high-salt brine stream portions 111G-1 and 111G-2 and is transmitted to an electrochemical reactor (not shown) that processes high-salt brine stream (concentrate) 111G-1 and generates a reduced-salt stream 111G-2, an acid product stream and a base product stream in the manner described above with reference to electrochemical reactor 110 (FIG. 1).

Mixing device 170G is configured and operates in a manner that is consistent with the mixing devices described above in that it utilizes at least one mixing element (e.g., mixing element 172G-1) to modify (i.e., adjust the pH level of) a reduced-salt stream portion 111G-211, and utilizes at least one mixing element (e.g., mixing element 175G-1) to combine modified reduced-salt stream portion 111G-211 and seawater stream 51T such that a (first) feedwater pH level pH_{51F} of feedwater stream 51F1 supplied to SWRO unit 165G-1 is equal to a target/optimal feedwater stream pH level pH_{51F1-TARGET}. Mixing device 170G differs from previous embodiments in that it utilizes two pairs of mixing elements to generate the two feedwater streams 51F1 and 51F2 respectively supplied to SWRO unit 165G-1 and BWRO unit 165G-2. The first pair of mixing elements includes mixing element 172G-1, which is used to modify the pH level of a first modified reduced-salt stream portion 111G-211, and mixing element 175G-1, which functions to combine (mix) first modified reduced-salt stream portion 111G-211 and seawater stream 51T to produce feedwater stream 51F1 supplied to SWRO unit 165G-1. The second pair of mixing elements includes mixing element 172G-2, which is used to modify the pH level of a second modified reduced-salt stream portion 111G-212, and mixing element 175G-2, which functions to combine (mix) second modified reduced-salt stream portion 111-212 and brackish permeate stream 51B to produce feedwater stream 51F2 supplied to BWRO unit 165G-2.

Controller 190G is configured and operates in a manner that is consistent with the controllers described above in that it utilizes sensor data to determine at least one target/optimal feedwater pH level pH_{51F2-TARGET} (e.g., at which BWRO unit 165G-2 generates freshwater stream portion 115G-2 with high operating efficiency), utilizes target feedwater pH level pH_{51F2-TARGET} to determine a target reduced-salt pH level pH_{111-212-TARGET}, and then utilizes target reduced-salt pH level pH_{111-21-TARGET} to adjust/modify a pH level of reduced-salt stream portion 111G-211 (i.e., by controlling mixing element 172G-2) such that, when modified reduced-salt stream portion 111G-211 is subsequently mixed with brackish permeate stream 51B, the pH level of feedwater stream 51F2 is equal to the target/optimal feedwater pH level pH_{51F2-TARGET}. As set forth below, controller 190G differs from previous embodiments in that it performs method 200 (described above with reference to FIG. 2A) such that the operating efficiencies of both SWRO unit 165B-1 and BWRO unit 165B2 are optimized. That is, controller 190G performs the process of determining a target feedwater pH level (block 210, FIG. 2A) by determining a first target feedwater pH level pH_{51F1-TARGET} at which SWRO unit 165G-1 generates brackish permeate 51B with at a corresponding (first) high operating efficiency, and also determining a second target feedwater pH level pH_{51F2-TARGET} at which BWRO unit 165G-2 generates freshwater stream portion 115G-2 at a corresponding (second) high operating efficiency. Note that various factors (e.g., differences in the pH level of seawater 51T and brackish permeate 51B) may cause controller 190G to generate a value for feedwater pH level pH_{51F1-TARGET} that differs from a value for feedwater pH level pH_{51F2-TARGET}. Next, controller 190G performs the process of utilizing the feedwater pH level to determine a target reduced-salt pH level (block 220, FIG. 2A) by using (first) target feedwater pH level pH_{51F1-TARGET} and a seawater (first) pH level pH_{51T} (e.g., obtained by measuring seawater stream 51T using corresponding sensor, as indicated in FIG. 7) to determine a (first) target reduced-salt pH level pH_{111-211-TARGET}, and using (second) target feedwater pH level pH_{51F1-TARGET} and a brackish water (second) pH level pH_{51B} (e.g., obtained by measuring brackish permeate stream 51B using corresponding sensor, as indicated in FIG. 7) to determine a (second) target reduced-salt pH level pH_{111-212-TARGET}. Controller 190G then controls the modification of acid/base substance concentration in the reduced-salt stream (block 230, FIG. 2A) by modifying a first concentration of acid/base substance contained in (first) reduced-salt stream portion 111G-211 until a (first) reduced-salt stream pH level pH₁₁₁₋₂₁ of reduced-salt stream portion 111G-211 is equal to (first) target reduced-salt pH level pH_{111-211-TARGET}, and by modifying a second concentration of acid/base substance contained in (second) reduced-salt stream portion 111G-212 until a (second) reduced-salt stream pH level pH_{111G-212} of reduced-salt stream portion 111G-212 is equal to (second) target reduced-salt pH level pH_{111G-212-TARGET}. In the example shown in FIG. 7, controller 190G adjusts the acid/base concentration of reduced-salt stream portion 111G-211 by way of transmitting a first control signal C_{170G1}, which includes values corresponding to (first) target reduced-salt pH level pH_{111-211-TARGET}, to valve 172G-1, whereby valve 172G-1 is operably controlled to inject either an acid pH adjustment portion from acid product stream 112G-2 or a base pH adjustment portion from base product stream 113G-2 into reduced-salt stream section 111G-20, thereby generating reduced-salt stream portion 111G-211 with (first) target reduced-salt pH level pH_{111-211-TARGET}. Similarly, controller 190G adjusts the acid/base concentration of reduced-salt stream portion 111G-212 by way of transmitting a second control signal C_{170G2}, which includes values corresponding to (second) target reduced-salt pH level pH_{111G-212-TARGET}, to valve 172G-2, whereby valve 172G-2 is operably controlled to inject either an acid pH adjustment portion or a base pH adjustment portion into reduced-salt stream section 111G-20 to generate reduced-salt stream portion 111G-212 with (second) target reduced-salt pH level pH_{111G-212-TARGET}. With reduced-salt stream portions 111G-211 and 111G-212 generated in this manner, feedwater stream 51F1 is generated with a (first) feedwater pH level pH_{51F1} equal to target feedwater stream pH level pH_{51F1-TARGET} by way of combining (e.g., using mixing element 175G-1) reduced-salt stream portion 111G-211 and seawater stream 51T, and feedwater stream 51F2 is generated with a (second) feedwater pH level pH_{51F2} equal to target feedwater stream pH level pH_{51F1-TARGET} by way of combining (e.g., using mixing element 175G-2) reduced-salt stream portion 111-212 and brackish permeate stream 51B.

Although described with specific reference to exemplary single-pass and two-pass reverse-osmosis arrangements, the present invention may be utilized to improve the operating efficiency of a system utilizing other multi-pass or multi-stage reverse-osmosis arrangements. In view of the exemplary embodiments set forth above, it will be clear to those skilled in the art that the inventive features of the present invention are applicable to other embodiments as well, and that all of which are intended to fall within the scope of the present invention.

1. A seawater reverse-osmosis desalination method comprising:
utilizing at least one reverse osmosis unit to generate a freshwater stream by diverting salt from a feedwater stream into a high-salt brine stream, the feedwater stream including seawater having a first salt concentration and the high-salt brine stream having a second salt concentration that is greater than the first salt concentration;
utilizing an electrochemical reactor to generate a reduced-salt stream having a third salt concentration that is lower than the first salt concentration by converting the salt contained in the high-salt brine stream into an acid substance and a base substance such that the acid substance is primarily contained in an acid product stream and the base substance is primarily contained in a base product stream;
determining a target feedwater pH level;
utilizing the target feedwater pH level to determine a target reduced-salt pH level;
adjusting a reduced-salt stream pH level of the reduced-salt stream by modifying a concentration of one of the acid substance and the base substance contained in the reduced-salt stream until the reduced-salt stream pH level of the reduced-salt stream is equal to the target reduced-salt pH level; and
combining the reduced-salt stream and the seawater such that a feedwater pH level of the feedwater stream supplied to the reverse-osmosis unit is equal to the target feedwater stream pH level.

2. The method of claim 1, wherein determining the target feedwater pH level comprises using one or more sensors to systematically generate seawater chemistry values, each seawater chemistry value corresponding to a measured seawater chemistry of the seawater before being combined with the reduced-salt stream, and utilizing a control algorithm to determine a corresponding said target feedwater pH level at which an operating efficiency of the reverse osmosis unit is optimized for each said systematically generated seawater chemistry value.

3. The method of claim 1, wherein determining the target feedwater pH level comprises detecting a change in an operating efficiency of the RO unit, and utilizing a control algorithm to determine a corresponding said target feedwater pH level at which an operating efficiency of the reverse osmosis unit is optimized for each said change in operating efficiency.

4. The method of claim 2, wherein each systematically generated seawater chemistry value includes a corresponding seawater pH value, wherein determining the target reduced-salt pH level comprises generating a corresponding said target reduced-salt pH level for each said systematically generated seawater chemistry value, and wherein determining said each corresponding target reduced-salt pH level includes calculating a difference between the seawater pH level of said each systematically generated seawater chemistry value and its corresponding said target feedwater pH level.

5. The method of claim 1, wherein adjusting the reduced-salt stream pH level of the reduced-salt stream comprises:
determining a difference between said target reduced-salt pH level and a current reduced-salt pH level of the reduced-salt stream exiting the electrochemical reactor;
when said difference is less than a predetermined amount, controlling said electrochemical reactor such that the concentration of one of the acid substance and the base substance contained in the reduced-salt stream exiting electrochemical reactor is modified such that a resulting adjusted reduced-salt pH level of the reduced-salt stream exiting electrochemical reactor is equal to the target reduced-salt pH level; and
when said difference is greater than the predetermined amount, modifying the concentration of one of the acid substance and the base substance contained in the reduced-salt stream by controlling the mixing device to inject one of an acid pH adjustment portion of the acid product stream and a base pH adjustment portion of the base product stream into the reduced-salt stream such that a resulting adjusted reduced-salt pH level of the reduced-salt stream is equal to the target reduced-salt pH level.

6. The method of claim 5, wherein controlling the mixing device comprises:
injecting a base pH adjustment portion of the base product stream into the reduced-salt stream when the initial reduced-salt stream pH level of the reduced-salt stream exiting the electrochemical reactor is less than the target reduced-salt pH level, and
injecting an acid pH adjustment portion of the acid product stream into the reduced-salt stream when an initial reduced-salt stream pH level of the reduced-salt stream exiting the electrochemical reactor is greater than the target reduced-salt pH level.

7. The method of claim 6, wherein injecting said base pH adjustment portion comprises:
utilizing a difference between said target reduced-salt pH level and the initial reduced-salt pH level and a flow rate of the reduced-salt stream to determine the base pH adjustment portion; and
controlling at least one valve of the mixing device to transfer the base pH adjustment portion from the base product stream into the reduced-salt stream through said at least one valve while isolating the acid product stream from the reduced-salt stream.

8. The method of claim 6, wherein injecting said acid pH adjustment portion comprises:
utilizing a difference between said target reduced-salt pH level and the initial reduced-salt pH level and a flow rate of the reduced-salt stream to determine the acid pH adjustment portion; and
controlling at least one valve of the mixing device to transfer the acid pH adjustment portion from the acid product stream into the reduced-salt stream through said at least one valve while isolating the base product stream from the reduced-salt stream.

9. The method of claim 5, wherein modifying said concentration comprises adjusting one or more operating parameters of the electrochemical reactor such that the reduced-salt stream exiting the electrochemical reactor includes the modified concentration of said one of the acid substance and the base substance.

10. The method of claim 1, further comprising:
transporting the seawater from an ocean to a desalination subsystem including said at least one reverse osmosis unit;
generating an ocean alkalinity product using a second portion of the base product stream such that the ocean alkalinity product includes said base substance fully dissolved in a salt solution and has a pH level that is a predetermined amount higher than a seawater pH level of the seawater; and
supplying the ocean alkalinity product to the ocean at a designated outfall location.

11. The method of claim 1, further comprising: transporting the seawater from an ocean to a desalination subsystem including said at least one reverse osmosis unit;
generating an alkaline slurry by combining a second portion of the acid product stream with an alkaline aggregate such that a reaction between the alkaline aggregate and the acid substance both neutralizes the acid molecules and etches the alkaline aggregate; and
supplying the alkaline slurry to the ocean at a designated outfall location.

12. The method of claim 1,
wherein utilizing said at least one reverse osmosis unit includes utilizing a first reverse osmosis unit and a second reverse osmosis unit, the first reverse osmosis unit being configured to receive the feedwater stream and to generate a brackish permeate having a fourth salt concentration that is between the first salt concentration and the second salt concentration, the second reverse osmosis unit being configured to receive a second feedwater stream including the brackish permeate;
wherein determining said target feedwater pH level comprises determining a first target feedwater pH level at which the first reverse osmosis unit generates a brackish permeate with a first high operating efficiency and determining a second target feedwater pH level at which the second reverse osmosis unit generates the freshwater stream with a second high operating efficiency;
wherein said utilizing comprises using the first target feedwater pH level and a first pH level of the seawater to determine a first target reduced-salt pH level and using the second target feedwater pH level and a second pH level of the brackish permeate to determine a second target reduced-salt pH level;
wherein modifying said concentration comprises modifying a first concentration of one of the acid substance and the base substance contained in a first portion of the reduced-salt stream until a first reduced-salt stream pH level of the first reduced-salt stream portion is equal to the first target reduced-salt pH level, and modifying a second concentration of one of the acid substance and the base substance contained in a second portion of the reduced-salt stream until a second reduced-salt stream pH level of the second reduced-salt stream portion is equal to the second target reduced-salt pH level; and
wherein said combining comprises combining the first reduced-salt stream portion and the seawater such that a first feedwater pH level of the feedwater stream supplied to the first reverse-osmosis unit is equal to the first target feedwater stream pH level, and combining the second reduced-salt stream portion and the brackish permeate such that a second feedwater pH level of the feedwater stream supplied to the second reverse-osmosis unit is equal to the second target feedwater stream pH level.

13. A seawater reverse-osmosis desalination system comprising:
a reverse osmosis unit configured to generate a freshwater stream by diverting salt from a feedwater stream into a high-salt brine stream, wherein the feedwater stream including seawater having a first salt concentration, and wherein the high-salt brine stream has a second salt concentration that is greater than the first salt concentration;
an electrochemical reactor configured to generate a reduced-salt stream having a third salt concentration that is lower than the first salt concentration by converting the salt contained in the high-salt brine stream into an acid substance and a base substance such that the acid substance is primarily contained in an acid product stream and the base substance is primarily contained in a base product stream;
a mixing device configured to generate the feedwater stream supplied to the reverse osmosis unit by combining the reduced-salt stream and a seawater stream including said seawater; and
a control system configured to:
determine a target feedwater pH level;
determine a target reduced-salt pH level utilizing the target feedwater pH level and a seawater pH level of the seawater used to form the feedwater stream; and
control one of the electrochemical reactor and the mixing device to modify a concentration of one of the acid substance and the base substance contained in the reduced-salt stream until a reduced-salt stream pH level of the reduced-salt stream is equal to the target reduced-salt pH level, whereby subsequent mixing of the reduced-salt stream and the seawater stream causes the feedwater stream to have a feedwater pH level that is equal to the target feedwater stream pH level.

14. The system of claim 13, wherein the control system comprises a controller and one or more first sensors configured to systematically generate seawater chemistry values, each seawater chemistry value corresponding to a measured seawater chemistry of the seawater before being combined with the reduced-salt stream, wherein the controller is configured to use a control algorithm to determine a corresponding said target feedwater pH level at which an operating efficiency of the reverse osmosis unit is optimized for each said systematically generated seawater chemistry value.

15. The system of claim 13, wherein the control system comprises a controller and one or more first sensors configured to determine the target feedwater pH level by detecting a change in an operating efficiency of the RO unit, wherein the controller is further configured to utilize a control algorithm to determine a corresponding said target feedwater pH level at which an operating efficiency of the reverse osmosis unit is optimized for each said change in operating efficiency.

16. The system of claim 13, wherein the mixing device comprises:
a first mixing element configured to generate a modified reduced-salt stream portion by combining the reduced-salt stream exiting the electrochemical reactor with one of an acid pH adjustment portion of the acid product stream and a base pH adjustment portion of the base product stream; and
a second mixing element configured to generate the feedwater stream supplied to the reverse osmosis unit by combining the modified reduced-salt stream and the seawater stream.

17. The system of claim 13,
wherein the electrochemical reactor comprises an electrodialysis apparatus, a fluid buffering system and a flow control system, and
wherein the control system is configured to modify said concentration of one of the acid substance and the base substance contained in the reduced-salt stream exiting the electrochemical reactor by adjusting one or more operating parameters of at least one of the electrodialysis apparatus, the fluid buffering system and the flow control system.

18. The system of claim 13, the electrochemical reactor comprises a post-production unit configured to selectively utilize a portion of the base product stream to generate an ocean alkalinity product and to supply the ocean alkalinity product to the ocean at a designated outfall location.

19. The system of claim 13, the electrochemical reactor comprises a post-production unit configured to selectively utilize a portion of the acid product stream to generate an alkaline slurry and to supply the alkaline slurry to the ocean at a designated outfall location.

20. The system of claim 13, further comprising a seawater desalination system including said reverse osmosis unit and at least one second reverse osmosis unit arranged in one of a multi-pass reverse-osmosis arrangement and a multi-stage reverse-osmosis arrangement.
